(19) United States
(12) Patent Application Publication
(10) Pub. No.: US 2022/0016711 A1
(43) Pub. Date: Jan. 20, 2022

(54) COMPOSITES, TOOLING AND METHODS OF MANUFACTURING THEREOF

(71) Applicant: MARKFORGED, INC., Watertown, MA (US)

(72) Inventors: Maxim Seleznev, Belmont, MA (US); Joseph Roy-Mayhew, Watertown, MA (US)

(21) Appl. No.: 17/376,689

(22) Filed: Jul. 15, 2021

Related U.S. Application Data
(60) Provisional application No. 63/052,387, filed on Jul. 15, 2020.

(51) Int. Cl. B22F 10/60; B33Y 40/20; B33Y 80/00; B22C 9/10; B22F 10/18; B33Y 10/00

(52) U.S. Cl. CPC B22F 10/60; B33Y 40/20; B33Y 80/00; B22F 2301/205; B22F 10/18; B33Y 10/00; B22F 2301/35; B22C 9/10

(57) ABSTRACT

Metal composites, tooling and methods of additively manufacturing these are disclosed. Metal objects and structures as provided herein are additively manufactured from metal having an infill pattern infiltrated with a second metal. Also provided herein are methods of forming such objects and structures. Methods include additively manufacturing a metal structure having an interior printed using an infill. Steps can further include infiltrating the printed infill of the structure with a liquid metal thereby forming a bi-metal composite.

### CROSS-REFERENCE TO RELATED APPLICATIONS

This application claims priority under 35 U.S.C. § 119(e) to U.S. Provisional Application Ser. No. 63/052,387, titled “Composites, Tooling, And Methods of Manufacturing Thereof” filed Jul. 15, 2020, the disclosure of which is incorporated herein by reference in its entirety for all purposes.

### BACKGROUND

Additive manufacturing refers to any one of various manufacturing technologies to three-dimensionally build objects in an additive fashion, for example, in a layer-by-layer manner.

### SUMMARY

The present disclosure generally relates to additive manufacturing, including 3D printing of composites, structural tools, dies, dies for injection molds, tooling, and methods for manufacturing such composites and tooling. More particularly, and without limitation, the disclosed embodiments relate to, among other things, systems, and methods for performing additive manufacturing and forming metallic objects having a composite structure. Metallic composites, structural parts or objects, tooling, and dies as provided herein may be formed from two or more metals.

In some embodiments, the present disclosure includes a method of making a part including printing the part or at least a portion thereof. The step of printing the part can include printing a first metal where the first metal forms a wall that substantially encloses an interior volume of the part. The step of printing can further include printing an infill portion within the interior volume of the part where the infill has a pattern that defines geometric structures within the interior volume. The method can further include infiltrating the part with a second metal having a lower melting temperature than the first metal. When melted and infiltrated, the second molten metal substantially surrounds the infill patterned structures thereby filling the space within the interior volume of the part.

In some aspects, methods of the present disclosure further include printing one or more channels within and traversing through the interior volume of the part.

In some aspects, the first metal can be any structural metal capable of printing, for example, steel or titanium. In some aspects, the second metal can be any structural metal capable of flowing like a liquid, for example, copper or magnesium. In certain aspects, the first metal is steel and the second metal is copper. In certain aspects, the first metal is steel and the second metal is magnesium. In certain aspects, the first metal is titanium and the second metal is magnesium.

In some aspects, the infill portion is a continuous gyroid geometry. In some aspects, a percent infill for the continuous gyroid geometry is between about 50% and about 60% of the interior volume. In some aspects, the infill portion is an alternating stacked rectangular infill geometry. In some aspects, a percent infill for the alternating stacked rectangular infill geometry is between about 0% and about 100%. In certain aspects, the percent infill is about 50% to about 60% of the interior volume.

In some aspects, the second metal can flow unimpeded through the internal volume during the infiltrating step. In some aspects, the second metal substantially fills empty space within the interior volume.

In some aspects, the method further includes applying a protectant on an outside surface of the part before infiltration to prevent the second metal from freely flowing in areas where it is not intended by a user. In some aspects, a protectant is a stop-braze.

In some aspects, prior to the step of infiltrating, the method can include a step of forming one or more openings in the wall or the shell of the first material that surrounds the interior volume of the part. In some aspects, prior to the step of infiltrating, the method can include a step of suspending a volume of the second metal above the one or more openings. In some aspects, the step of infiltrating can include a step of heating. In some aspects, the step of infiltrating can include a step of heating in a reducing argon atmosphere.

In some embodiments, the present disclosure provides composite metal objects. In some aspects, metal composites as provided herein include an outer metal shell having a first metal defining an interior volume and a patterned infill that is also made of the first metal located within the interior volume. The patterned infill can occupy a percentage of the interior volume. The interior volume can also include a second metal that substantially surrounds the infill patterned first metal.

In some embodiments, the present disclosure provides a metal die insert for a mold, for example for use with injection molding. In some aspects, the die or mold includes an outer metal shell having a first metal that defines a volume of the mold. In some aspects, the mold further includes a patterned infill made of the first metal located within the interior volume. As above described, the infill pattern can fill a percentage of the interior volume of the mold. The interior volume can also include a second metal substantially surrounding the infill patterned first metal. The interior volume can also include one or more fluid tight channels enclosed within and traversing through the mold.

In some aspects, the first metal can be any structural metal capable of printing, for example, steel or titanium. In some aspects, the second metal can be any structural metal capable of flowing like a liquid, for example, copper or magnesium. In certain aspects, the first metal is steel and the second metal is copper. In certain aspects, the first metal is steel and the second metal is magnesium. In certain aspects, the first metal is titanium and the second metal is magnesium.

In some aspects, the first metal of the mold can be any structural metal capable of printing, for example, steel or titanium. In some aspects, the second metal of the mold can be any structural metal capable of flowing like a liquid, for example, copper or magnesium.

In some aspects, the outer shell is substantially that of the first metal.

In some aspects, the second metal occupies empty space within any defects at an interface between the interior volume and the shell. For example, the defects may be pores.

These and other capabilities of the disclosure, along with the disclosure itself, will be more fully understood after a review of the following figures, detailed description, and claims.

### BRIEF DESCRIPTION OF THE DRAWINGS

Various aspects of one or more embodiments are discussed below with reference to the accompanying figures, which are not intended to be drawn to scale. The figures are included to provide an illustration and a further understanding of the various aspects and embodiments. The figures are incorporated in and constitute a part of this specification. But the figures are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a schematic representation illustrating an object or part in accordance with various embodiments of the present disclosure.

FIG. 2 is a schematic representation illustrating an object or part in accordance with other various embodiments of the present disclosure.

FIG. 3 is a flow chart for performing 3D-printing an object and infiltrating the object to form a metal composite, in accordance with various embodiments of the present disclosure.

FIGS. 4A-4D show a schematic representation showing the process flow for infiltrating an object, in accordance with various embodiments of the present disclosure. FIG. 4A shows suspending a volume of the second metal, for example a copper plate above the one or more openings that are formed in the shell of first metal volume. FIG. 4B shows heating the second metal in a reducing argon atmosphere to induce melting of the second metal. FIG. 4C shows heating the second metal in a reducing argon atmosphere while infusing it into the empty space between the patterned infill structures within the internal volume of the first metal. FIG. 4D shows continued heating of the second metal in a reducing argon atmosphere while infusing it into the empty space between the patterned infill structures within the internal volume of the first metal. FIG. 4E shows continued heating the second metal in a reducing argon atmosphere while infusing it into the empty space between the patterned infill structures within the internal volume of the first metal until the empty space within the volume is filled or a supply of the second metal is expended. FIG. 4F shows cooling the part in a reducing argon atmosphere.

FIGS. 5A and 5B illustrate a comparison of metal additive manufacturing parts and platforms for producing large parts. FIG. 5A shows a solid part. FIG. 5B shows a part fabricated by additive manufacturing including infill structures.

FIG. 6 is a flow chart for performing 3D-printing and infiltrating to form tool structures, dies, and die inserts, in accordance with various embodiments of the present disclosure.

FIG. 7 is an image illustrating a printed green part for a die insert for use with injection molding.

FIG. 8 is an image illustrating one or more openings formed in a green part, in which the one or more openings permit access for a liquid second metal to infiltrate the internal volume of the part.

FIG. 9 is an image illustrating a die for injection molding in accordance with embodiments of the present disclosure.

FIGS. 10A and 10B illustrate sliced parts following electrical discharge machining (EDM) of a die for injection molding as provided herein. FIG. 10A shows an EDM slice of such a die visible from a top side of the die. FIG. 10B shows a slice of such a die visible from a side of the die showing the internal volume.

FIGS. 11A-11B illustrate sliced parts following EDM of a die for injection molding as provided herein. FIG. 11A shows a portion of a part formed from an EDM slice from a side showing the internal volume. FIG. 11B shows a portion of a part formed from an EDM slice from a side of a die showing the internal volume.

FIG. 12 is an image of an iron-copper phase diagram.

FIGS. 13A and 13B shows a die insert for injection molding used for material microstructure analysis. FIG. 13A shows the locations where 6-mm diameter cylinders were cut out of the die for material microstructure analysis. FIG. 13B shows the cylinders intercepted internal die cooling channels.

FIG. 14 shows an image of a microstructure of a bulk cross-section of the copper/steel infill composite having a spot marked by an ‘X’.

FIGS. 15A and 15B show SEM images of the microstructure taken at the ‘X’ spot from FIG. 14. FIG. 15A shows a low magnification SEM image of the microstructure. FIG. 15B shows high magnification of the microstructure.

FIGS. 16A and 16B show the results of a quantitative energy dispersive X-ray spectroscopic (EDS) analysis. FIG. 16A and FIG. 16B show image results of a quantitative EDS analysis combined with X-ray mapping of the area marked with the ‘X’ from FIG. 14.

FIGS. 17A and 17B show SEM images of the microstructure of a higher contrast copper area. FIG. 17A shows a low magnification SEM image of the microstructure. FIG. 17B shows a high magnification image of the microstructure.

FIGS. 18A and 18B show the results of a quantitative EDS analysis. FIG. 18A and FIG. 18B show the quantitative EDS analysis combined with X-ray mapping of the brighter contrast copper area.

FIGS. 19A and 19B show the interface between a copper matrix and a steel reinforced section. FIG. 19A shows the SEM image with an ‘X’ at the analyzed area. FIG. 19B shows a high magnification SEM image of the area marked by the ‘X’.

FIGS. 20A-20C show the results of a quantitative EDS analysis performed over three different areas across an infill segment.

FIG. 21 shows an SEM image, results and analysis of a line scan traversing an interface between steel and copper.

FIGS. 22A and 22B shows the image results and analysis of the outer shell of the die insert for use with injection molding. FIG. 22A shows an image of the outer shell and marks the location for analysis with an ‘X’. FIG. 22B shows the results of the analysis for the location.

FIGS. 23A and 23B shows the image results and analysis of a cooling channel of the die insert for the mold. FIG. 23A shows an image of the cooling channel and marks the location for analysis with an ‘X’. FIG. 23B shows the image result of the analysis for the marked location.

FIG. 24 shows a photographic image of the sintered block.

FIG. 25 shows a photo of several parts in a container prior to infiltration.

FIG. 26 is a schematic representation showing the location in the composite block in which thermal conductivity and compression samples were obtained.

FIG. 27 shows an image of the thermal conductivity and compression samples after they prepared and cut away from the composite block.

FIG. 28 shows the data produced from the thermal conductivity tests of the samples.

FIG. 29 shows the data produced from the compression tests of the samples.

FIG. 30 shows a plot of the compressive stress v. Strain data collected for the samples.

FIG. 31 shows extrapolated strength data for the samples.

FIG. 32 shows stress-strain curves for bi-metal composites of H13 tool steel and C-194 copper with different infill geometries.

FIG. 33 shows characteristic X-ray maps of the copper infiltrant area of a 17-4 stainless steel-copper bi-metal composite containing precipitated particles and EDS analysis results of the whole area and of copper matrix in-between the precipitates.

FIGS. 34A and 34B show cross-sectional views of molds made with different steels and different copper infiltrants. FIG. 34A shows a wire EDM cross-section through the gate area of a 17-4PH steel mold infiltrated with copper. FIG. 34B shows a milled cross-section through the gate area of a H13 tool steel mold infiltrated with C194 copper alloy.

FIGS. 35A-35D show the microstructure of a H13 tool steel-C-194 copper alloy bi-metal composite material. FIG. 35A shows a general view of the sintered steel infill fragment surrounded by copper infiltrant. FIG. 35B shows a high magnification view of the infill fragment microstructure of FIG. 35A. FIG. 35C shows a general view of the copper infiltrant microstructure. FIG. 35D shows a high magnification view of the copper infiltrant microstructure of FIG. 35C.

FIG. 36 shows characteristic X-ray maps of the copper infiltrant area of a H13 tool steel-C-194 copper bi-metal composite containing precipitated particles and EDS analysis results of the whole area and of copper matrix in-between the precipitates.

The features and advantages of the disclosure are apparent from the detailed specification, and thus, it is intended that the appended claims cover all systems and methods falling within the true spirit and scope of the disclosure. As used herein, the indefinite articles “a” and “an” mean “at least one” or “one or more.” Similarly, the use of a plural term does not necessarily denote a plurality unless it is unambiguous in the given context. Words such as “and” or “or” mean “and/or” unless specifically directed otherwise. In this application, the terms “comprising” and “including” may be understood to encompass itemized components or steps whether presented by themselves or together with one or more additional components or steps. Unless otherwise stated, the terms “about” and “approximately” may be understood to permit standard variation as would be understood by those of ordinary skill in the art. Where ranges are provided herein, the endpoints are included. As used in this application, the term “comprise” and variations of the term, such as “comprising” and “comprises,” are not intended to exclude other additives, components, integers or steps.

As used in this application, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Many methodologies described herein include a step of “determining.” Those of ordinary skill in the art, reading the present specification, will appreciate that such “determining” can utilize or be accomplished through use of any of a variety of techniques available to those skilled in the art, including for example specific techniques explicitly referred to herein. In some embodiments, determining involves manipulation of a physical sample. In some embodiments, determining involves consideration and/or manipulation of data or information, for example utilizing a computer or other processing unit adapted to perform a relevant analysis. In some embodiments, determining involves receiving relevant information and/or materials from a source. In some embodiments, determining involves comparing one or more features of a sample or entity to a comparable reference.

As used herein, the term “substantially”, and grammatic equivalents, refer to the qualitative condition of exhibiting total or near-total extent or degree of a characteristic or property of interest. One of ordinary skill in the art will understand that chemical phenomena rarely, if ever, go to completion and/or proceed to completeness or achieve or avoid an absolute result.

### DETAILED DESCRIPTION

Among other things, the present disclosure provides composite metal materials, objects, structures, parts, molds, and dies. Dies and die inserts as provided herein may be useful with injection molding processes. Methods for manufacturing these are also disclosed herein. Various embodiments according to the present disclosure are described in detail herein.

The present disclosure includes compositions and composite objects and their use in various applications, including, for example: leak tight or leak resistant parts or structures, for example, in cooling channels in dies, die inserts, molds, etc. The present disclosure envisions cooling channels in molds, for example that can be extended to encompass conformal cooling channels in tool steel molds and dies. Indeed, more broadly the present disclosure encompasses a recognition that cooling channels, such as these, may be useful or desirable for any object fabricated by an additive manufacturing process and where the object may include producing walls that include the flow of gas or liquids.

In subtractive manufacturing, three-dimensional (3D) objects are manufactured by cutting away material from an initial block (or other shape) of material. For example, computer numeric controlled (CNC) machines may be initialized and tuned by an operator to create a particular part. Specifically, the operator may supply a program (e.g., using G-code) that instructs the machine how to make the part. An input material larger than the desired part is provided to the machine. The machine's tool (or multiple tools, depending on the machine) carve away the material, according to the program, to reveal the shape of the specified part.

In such traditional subtractive manufacturing, removing material from a solid block presents numerous issues in the context of creating, designing and building channels for the flow of fluid. First, carving metal is a time and labor-intensive process that requires a tool to cut and wear on some other softer metal material. Second, designing and pathing the channels to optimize cooling is a challenge in view of the limitations presented by line of sight in material removal. That is, the cooling channels are limited by the ability of the tooling to bore, cut, drill, mill, etc.

Additive manufacturing, sometimes more generally known as three-dimensional printing, refers to a class of technologies for the direct fabrication of physical products from a three-dimensional computer model by a layered manufacturing process. In contrast to material removal processes in traditional subtractive manufacturing, the three-dimensional printing process adds material. In additive manufacturing, 3D parts are manufactured by adding layer-upon-layer of material. For example, an additive manufacturing-based 3D printing device can create a 3D part, based on a digital representation of the part, by depositing a part material along toolpaths in a layer-by-layer manner. This process can enable the direct printing of products with extremely complex geometry.

Fused Deposition Modeling (FDM) also referred to as Fused Filament Fabrication (FFF) is an example of additive manufacturing technology used for modeling, production, and prototyping. In an FDM, FFF additive manufacturing process, a moving print head extrudes a filament of material onto a print bed or to an object being printed. The print head and/or the print bed can move relative to each other under computer control to define the printed object.

Additive manufacturing of a layer generally involves slicing a two-dimensional layer into a series of shells, that is beads, lines, or shells. The printing of a layer is typically done shell-by-shell until the one or more shells (i.e., the plurality of shells) are complete. For example, each two-dimensional layer may have a number of shells lining a contour, such as a perimeter of a wall. The process of depositing or extruding shells is typically in a machine-controlled manner according to slicing parameters. Additionally, for example, printing of subsequent shells may include extruding by tracing along a contour or path defined by a prior printed shell. A result of such a process can be a repeatable and consistent extrusion.

Moreover, each two-dimensional layer may have a different fill pattern filling the interior of the part. Additionally, a fill pattern may be deposited between an inner and an outer perimeter of a wall.

In a fused deposition additive manufacturing system, a three-dimensional part or model may be printed from a digital representation of the three-dimensional part in a layer-by-layer manner by extruding a flowable part material along toolpaths.

The print head can move in two dimensions to deposit one horizontal plane or a layer of the object. Then, the print head or the print bed can be moved vertically by a small amount to begin another horizontal plane, a new layer of the object. The part material is extruded through an extrusion tip carried by a print head of a three-dimensional printing apparatus, device, or system. Part material is deposited as a sequence of roads on a substrate in a build plane.

Additive manufacturing of an object, for example, a fused deposition additive manufacturing process, involves slicing a three-dimensional object into a plurality of two-dimensional layers that are stacked on top of one another (that is, along the z-axis). In an additive manufacturing process, stacking could commence, for example at a build plate. Generally, printing of the object is done layer-by-layer. Layer-by-layer the layers of the object are formed. The position of the print head relative to the substrate is then incremented along one or more print axes, and the process can then be repeated to form an object, i.e., a three-dimensional part, resembling the digital representation.

A layer, for example, a first layer is deposited (i.e., extruded) onto the build surface. That is, for example, a horizontal layer is printed with movement in the X-Y axis. Once this first horizontal layer is completed, a height adjustment is made in the Z axis. Another horizontal layer of is printed with movement in the X-Y axis. Once the next horizontal layer is completed, another height adjustment is made in the Z axis. This process continues, for each layer until the object is completed.

### Composites

In some embodiments, the present disclosure provides compositions and composites of metal. In some aspects, metal composites include one or more metals in a composite structure. In some aspects, the composite structure includes an outer shell of at least one metal. In some aspects, the outer shell of the composite structure defines a volume.

In some aspects, the outer shell of the composite structure is or includes one or more layers a first metal. Commercially valuable metals suitable for printing include aluminum, copper, steel, e.g., stainless steel or tool steel, titanium, and/or alloys thereof. In some aspects, the metal be a metal resistant to oxidation at both high and low temperatures (e.g., amorphous metal). In some aspects, the first metal is characterized by its melting temperature.

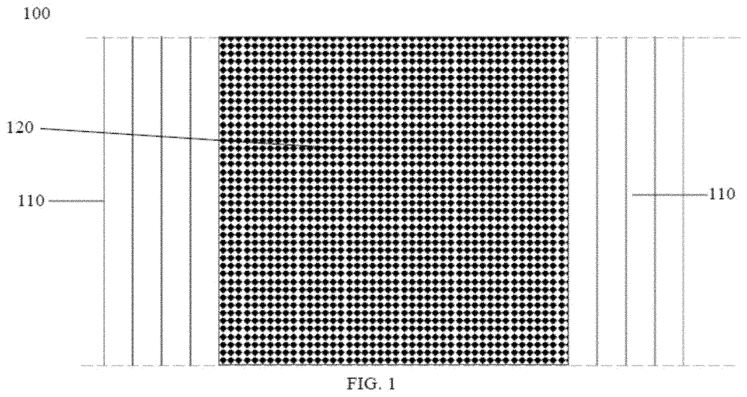

In some aspects, the outer shell defines a volume within the shell. In some aspects, the volume is at least partially occupied by an infill. The infill may be made of or includes the first metal. FIG. 1 is a schematic representation illustrating a portion of a volume of an object 100. An outer shell 110 is shown bordering an infill section 120. The outer shell 110 and infill section 120 include or made of the first metal.

In some aspects, the infill is or includes a pattern having a repeated geometric structure within the volume. In some aspects, the infill is defined or characterized by the amount, density, or percentage of the volume occupied. In some aspects, the infill is between about 0% and about 100% of the occupied volume. In some aspects, the infill is about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the occupied volume. In some aspects, the infill may be about 40% to about 70% of the occupied volume, e.g., about 40% to about 70% of the occupied volume, 45% to about 65% of the occupied volume, or about 50% to about 60% of the occupied volume.

In some aspects, the internal structure of the solid bodies herein may be 3D printed with porous, cellular, or hollow infill patterns. In some aspects, the patterns are repeating patterns having geometric shapes. In some aspects, the geometric patterns can include, for example, diamond, gyroid, honeycomb, rectangle, triangle, or other similar geometric patterns.

In some aspects, the internal structure can include additional features, for example, one or more channels that traverse through the internal structure. In some aspects, the channels are straight. In some aspects, the channels bend or curve within an object or mold. In some aspects, the channels are leak tight. In some aspects, the channels permit fluid flow. In some aspects, the channels transfer a cooling fluid, such as water.

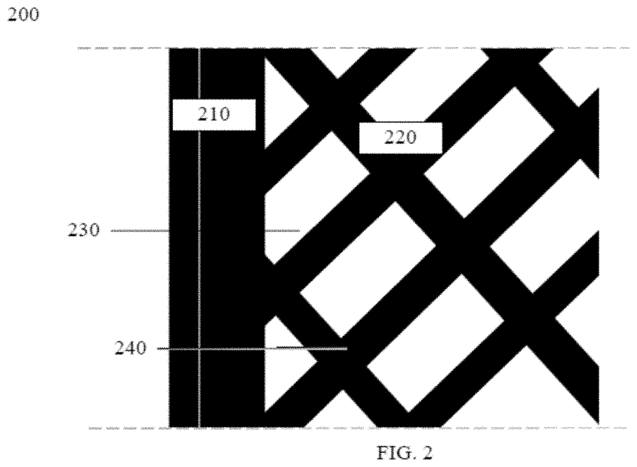

In some aspects, the metal compositions include at least a second metal. The second metal can be substantially infused or infiltrated between the infill patterned first metal within the interior volume of the shell of the part. FIG. 2 is a schematic representation illustrating a portion of a volume of an object 200. An outer shell 210 is shown bordering an interior portion 220. The outer shell 210 and an infill section 240 include or made of the first metal. An area 230 surrounding the infill section is shown infiltrated with a second metal. The second metal has a lower melting temperature than the first metal.

In some aspects, the second metal substantially fills all of the empty volume of the interior volume of the shell. In some aspects, the second metal substantially fills and surrounds and empty space within the interior volume of the shell that is not occupied by the infill. In some aspects, the second metal fills voids and/or imperfections in the shell of the first metal.

In some aspects, the second metal can be any metal having capable of flowing like a fluid, such a liquid metal. In some aspects, the second metal may be aluminum, copper, steel, e.g., stainless steel or tool steel, titanium, magnesium, and/or alloys thereof. In some aspects, the second metal may be resistant to oxidation at both high and low temperatures (e.g., amorphous metal). In some aspects, the second metal can be any metal having a melting point lower than that of the first metal.

In general, the first metal used to print a part generally should be more refractory than the second, i.e., infiltrant, metal and that the second metal in a liquid state should be largely inert to the first metal. In other words, the first metal remains solid and has limited solubility in the second metal when liquified at the infiltration temperature. Examples of such first and second metal pairs are iron-magnesium and titanium-magnesium systems. Steel-magnesium and titanium-magnesium systems are noteworthy because iron and titanium are not soluble in liquid magnesium, at least not at the temperature range of 50° C. to 100° C. above the magnesium (or any alloy thereof) liquidus temperature. Such composites could exhibit some useful properties. Magnesium would make the steel-magnesium composite lightweight, and at the same time increasing the stiffness and thermal conductivity compared to a steel part with only infill in the interior volume. Such a composite would retain high wear resistance due to the harder steel outer surface and have an increased vibrational damping capacity. Titanium-magnesium composites would exhibit similar properties, with titanium-magnesium composites being lighter in weight than steel-magnesium composites. The titanium outer shell would also impart increased corrosion resistance to the composite.

In some aspects, the composite structures are characterized by their properties. In some aspects, the composite structure is substantially a bi-metal composite. For example, in some aspects, the first metal may be a tool steel and the second metal may be copper. In some aspects, composite structures as provided herein include designs optimized for fluid transfer. In some aspects, composite structures as provided herein, for example, bi-metal steel and copper composites, provide enhanced thermal conductivity, strength, and modulus when compared with primarily single metal materials and structures formed from subtractive manufacturing methods.

### Methods

The present disclosure also provides methods of forming composite structures and objects as taught herein. Methods generally include printing a metal object having a substantially solid shell and a patterned infill within the volume of the shell. Methods further include infiltrating the volume with a second metal, in liquid form to make the metal composite object or part.

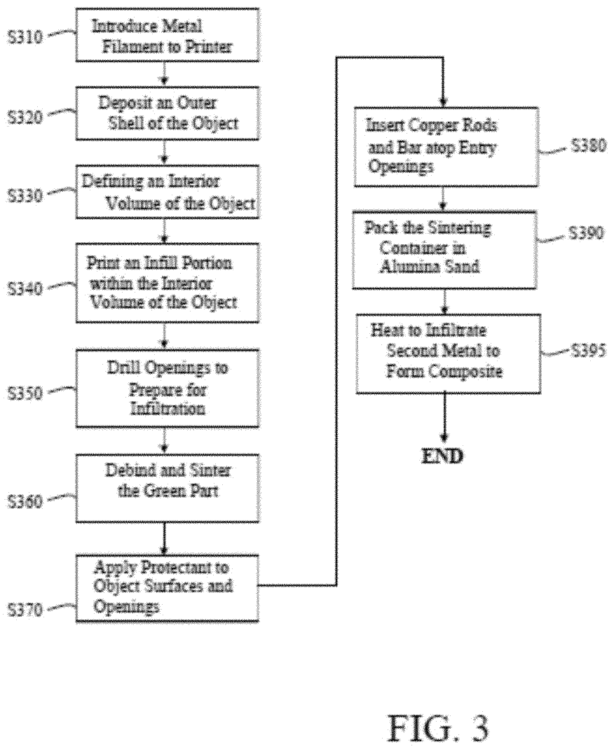

FIG. 3 is a flow chart for performing 3D printing of a shell and infiltrating the internal volume of the shell with a molten metal to form an object, that is, a composite metal, in accordance with various embodiments of the present disclosure.

Printing of an object involves introducing a metal filament, S310 for example a tool steel, e.g., H13, filament and depositing the metal along a toolpath to form an outer shell of the object, S320. The printed step further defines an interior volume of the object, S330. The printing step further defines an infill portion of the object within the interior volume. The object shell, interior volume, and infill are formed layer-by-layer as the object is printed, S340.

The resultant printed object, i.e., a green part, is prepared for composite infiltration. One or more openings are formed, for example, by drilling into the printed object for flowing a second molten or liquid metal into the internal volume of the object, S350. These openings were also formed to allow air to escape during the subsequent infiltration by the second metal, for example, copper.

Prior to infiltration these parts are debound and sintered, S360.

A protectant, for example alumina felt, alumina fiber, alumina sand, or a commercial braze stop-off coating, such as a liquid protectant, is applied to surfaces and various entries and exits to control wetting of the second metal during the infiltration process, S370. These protectants keep the second metal from depositing in locations where it is not wanted. As described herein, liquid protectant coatings can be applied by painting, air brushing, directing liquid protectant through the part under pressure, or by immersion. Other methods of applying protectant coatings or material would be known to one of skill in the art.

Copper rods were inserted into the openings. Specifically, copper rods are inserted into two infiltrant entry openings and capped with a copper bar, S380. The object was packed with alumina sand in a container leaving only the top surface of the copper bar exposed, S390. The container housing the object is placed into a sintering furnace and heated to between 1150° C. about 1190° C. in an argon reducing atmosphere, S395. After a period of time, either the volume of copper bar is expended, or the internal volume of the part is filled and infiltration completed.

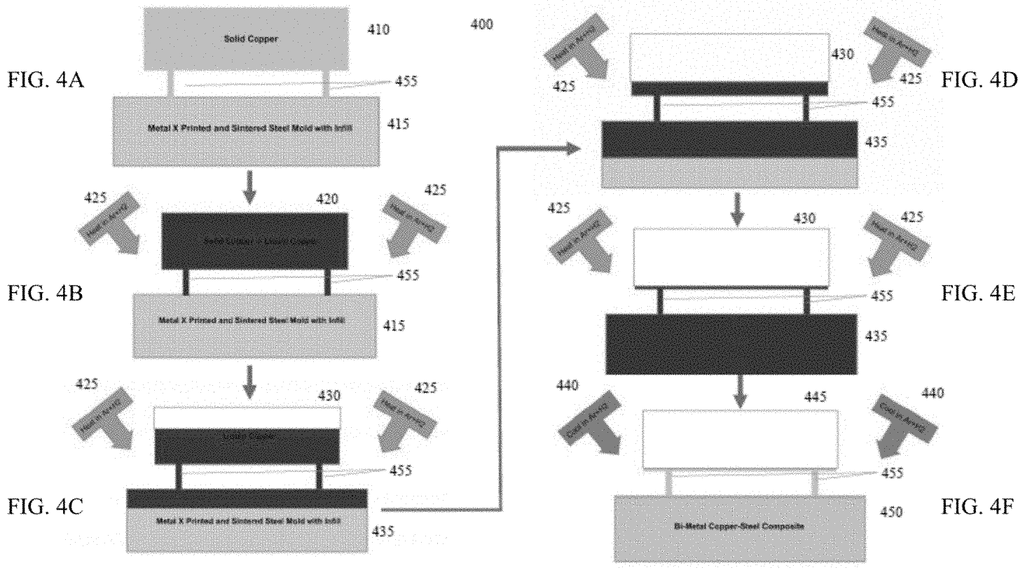

FIGS. 4A and 4B are schematic representations showing the process, 400 of forming a bi-metal composite. FIG. 4A shows a printed and sintered metal mold for use in an injection molding process, 415 having metal infill printed within the internal volume of the mold. A solid copper block 410 is placed atop or suspended by a pair of copper rods, each indicated at 455, that are affixed, inserted, or mounted to openings the surface of the mold.

FIG. 4B shows a printed and sintered metal mold 415 having metal infill printed within the mold volume. Heat and an argon reducing gas 425 are introduced such that the solid copper block positioned atop the copper rods 455 transitions to a mixture of solid copper and liquid copper 420.

FIG. 4C shows substantially liquid copper 430 suspended atop the pair of copper rods 455 mounted to the mold. The liquid copper is flowing and having partially infiltrated 435 into the mold and infill therein. Heat and an argon reducing gas 425 continue to flow such that the molten copper positioned atop the copper rods 455 remains liquid copper.

FIG. 4D and FIG. 4E show the substantially liquid copper 430 suspended atop the pair of copper rods 455 mounted to the mold. The liquid copper is flowing and having near fully infiltrated 435 into the mold and infill. Heat and an argon reducing gas 425 are continued such that the molten copper positioned atop the copper rods 455 remains liquid copper 445.

FIG. 4F shows bi-metal composite 450 substantially infiltrated with copper into the mold and infill. Cool argon reducing gas 440 is introduced to cool composite 450 and any remaining liquid copper 445 following infiltration.

### Applications

Structural parts, such tools, dies, and die inserts for plastic injection molding are a growing market for tooling. A prominent and growing area for use for such tooling and dies is in plastic injection molding. The plastic injection molding process generally includes, but is not limited to, steps of plastification, i.e., melting, injection, packing/cooling and demold/ejection to form molded parts. During the plastic injection molding process, the injection molds undergo substantial mechanical stress, reinforcing the need in the industry to improve or enhance the structural stiffness, surface wear resistance, and enhanced thermal conductivity over time in such structural tools, dies, and die inserts.

One aspect of improving the performance of injection molding dies is improving the cooling of the die while in use. Channels provide cooling and thermal conductivity. In more traditional dies, the die included linear cooling channels running near or through select areas of the die. In some aspects, dies produced using the systems and methods of this disclosure include conformal cooling channels. Conformal cooling may enhance cooling and improve thermal conductivity of the part. Effective die cooling directly translates into shorter cycles for making die molded parts, better die molded surface part quality, and fewer rejected parts. The ability to provide enhance conformal cooling channels is advantageous to such structural tools, dies, and die inserts for injection molding applications.

Subtractive manufacturing can provide options for strength, stiffness, thermal conductivity, and leak resistance. However, traditional machining provides limits on flexibility when designing objects and their internal structure, such as cooling channels.

Due to design flexibility however, the opportunity for additive manufacturing exists to expand and optimize within the conformal cooling and provide enhanced cooling capability for tooling molds and dies.

To date, the applicability of additive manufacturing to these uses, specifically structural tools, dies, and die inserts has been limited. Tooling and dies for plastic injection molds are often large in size. For example, injection molding dies are usually on an order of about 4″×4″×1″. Large tooling objects can create several issues for additive manufacturing. First, it takes a long time to 3D print large scale fully solid objects using FDM technology. Second, 3D printing of large parts may use an extensive volume of metal filament. Additionally, preparing large green printed parts for sintering increases the time and debinding chemical used to remove the binder material from the metal particles of the filament.

In response, to reduce metal filament material usage and to minimize both the print and wash times, additive manufacturing processing have employed the use of infill patterns to make or print large parts. Infill patterns print only a percentage of the volume of a fully solid object during printing. Infill patterns therefore serve the intended purpose, that is, they provide interior support to the outer shell of the part while using less material. By using less material, the part costs less in metal filament and takes less time to print and wash.

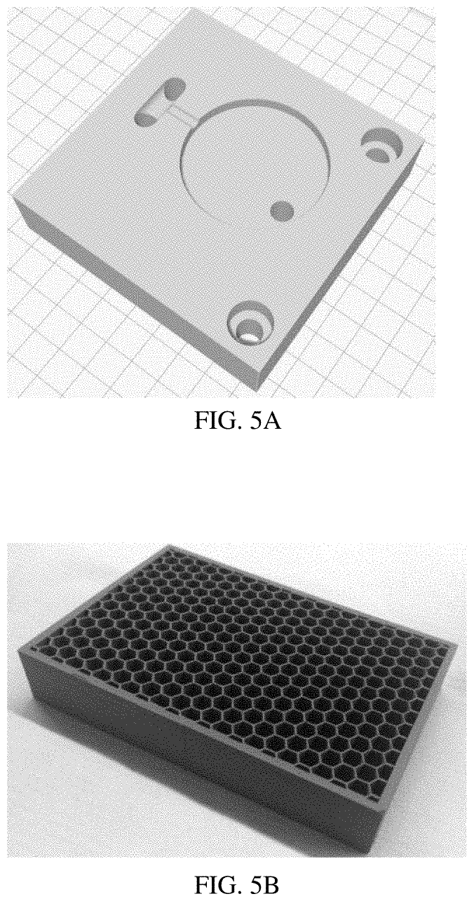

FIGS. 5A and 5B illustrate a comparison of metal additive manufacturing parts and platforms for producing large parts. FIG. 5A and FIG. 5B each illustrate injection molding dies 75×75×19 mm in size. FIG. 5A illustrates a solid part. FIG. 5B illustrates a part made of 35% infill material. The solid part at FIG. 5A is calculated to take 69 hours to print and 81 hours to wash. The 35% infill part at FIG. 5B is calculated to take 31 hours to print and 18 hours to wash. In addition to higher material cost, the solid fill parts are therefore clearly impractical for large objects due to long print and wash time cycles.

Structural tools, dies and die inserts for injection molding rely on characteristics or properties having high strength, high mold stiffness in compression, high surface wear resistance, and high thermal conductivity. Mechanical and/or the thermal properties of the printed infilled tool may suffer over the life of the tools when compared to a fully dense tool, e.g., an infilled tool may have a lower compressive stiffness and strength. Further, an infilled tool may have a reduced thermal conductivity. In addition, an infilled tool or tools, dies, and die inserts having conformal cooling channels may be susceptible to leaks.

Another state-of-the-art technique is powder metallurgy. Powder metallurgy permits partial sintering of the steel. Molten copper is then drawn into the open microscopic channels left by the partial sintered steel powder through a process via capillary forces.

The PM infiltrated copper overcomes some of the above drawbacks, improved thermal conductivity and stiffness relative to the empty infilled printed parts. However, there are drawbacks, including that the outside shell of the copper infiltrated PM steel is much softer than a subtractive or FDM 3D printed part because of large volume fraction of soft copper on the outer surface. The softer outer surface has a lower degree of strength and stiffness resulting in a less resistive part than either the solid or infilled parts.

### Composite Tooling

The present disclosure also provides for the production of composite tooling. Composite metal tooling and dies disclosed herein may be infiltrated such that a second metal infiltrates, fills, or surrounds the infill of the interior volume of the shell of the first metal of the tooling or die. The composite metal may enhance relatively low compressive stiffness, strength, and thermal conductivity of the infilled only parts. The outer surface remains substantially that of the first metal and as such the surface is wear resistant. Moreover, infiltrating the first metal infill with a second metal seals and reduces leaks, thereby enhancing water tightness. Finally, as the additively manufactured part is infill printed, the printing times, material usage, and wash times are substantially less when compared to solid parts.

The present disclosure encompasses a recognition that liquid copper wets to iron and steel at high temperatures. Without wishing to be bound to any particular theory, it is believed that with physical contact with a volume of steel infill and/or a surface area of steel shell, the liquid copper will wet to the steel, occupy, and fill the empty space with the interior of the steel mold.

Infill patterns and percentage of fills may be varied. For example, a gyroid is a type of pattern for filling a steel part with copper where much of the empty volume is fully interconnected. Fully interconnected infill patterns allow for liquid metal to flow freely within the volume and extend to fill the empty spaces within the interior of the mold.

Table 1 presents a summary of the properties of dies subtractively machined from steel, dies additively manufactured with 50% steel infill, and dies made in accordance with the present disclosure, i.e., additively manufactured with 50% steel infill and infiltrated with copper.

TABLE 1
Comparison of material properties made using subtractive
manufacturing and additive manufacturing.

| | | Percent | Bi-Metal |
|---|---|---|---|
| Property or | Machined | Infill (50% | Composite 50/50 |
| Features | Steel | Steel) | Copper-Steel |
| Stiffness | 200 | 100 | 160 |
| (Young's Modulus) | | | |
| (GPa) | | | |
| Thermal | 20 | 10 | >80 |
| Conductivity | | | |
| (W/mK) | | | |
| Leak-proof Cooling | Yes | No | Yes |
| Channels | Non-Conformal | | Conformal |
| Hard Mold Working | Yes | Yes | Yes |
| Surface | | | |
| Lead Time | >1 month | ~7 days | ~9 days |

Tools and dies made from composites of the present disclosure may have comparable or improved performance characteristics relative to those made from machined steel or by additive manufacturing with an infill made from a single metal. In particular, the infiltrated composite of the present disclosure is shown to have improved thermal conductivity over both the machined steel parts and the parts additively manufacturing with the single infill material. Moreover, the stiffness of the infiltrated composite of the present disclosure is near comparable to that of the machined steel.

Upon infiltration, the liquid copper fills the internal volume and extends to fill under-extrusion defects in the internal channel walls. The result increases the leak resistance of the bi-metal composite and parts made therefrom, e.g., dies and molds. The composition of the walls does not substantially change during infiltration. The chemical composition of the outer steel mold walls remains within the original steel specification prior to the copper infiltration process.

In some aspects, the infill may include a pattern having a repeated geometric structure within the volume. In some aspects, the infill may be defined or characterized by the amount, density, or percentage of the volume occupied. In some aspects, the infill is between about 0% and about 100%. In some aspects, the infill is about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the volume occupied. In some aspects, the infill may be about 40% to about 70% of the occupied volume, e.g., about 40% to about 70% of the occupied volume, 45% to about 65% of the occupied volume, or about 50% to about 60% of the occupied volume.

In some aspects, the internal structure of the solid bodies herein may be 3D printed with porous, cellular, or hollow infill patterns. In some aspects, the patterns are repeating patterns having geometric shapes. In some aspects, the geometric patterns can include, for example, diamond, gyroid, honeycomb, rectangle, triangle, etc.

### Methods

The present disclosure also provides methods of forming tool structures, dies, and die inserts as taught herein. As above noted, tool structures, dies, and die inserts manufactured according to these methods can be useful in injection molding processes. Methods disclosed herein generally include printing a metal object having a substantially solid shell, a patterned infill, and internal cooling channels within the volume of the shell. Methods further include infiltrating the volume with a second metal to form the composite.

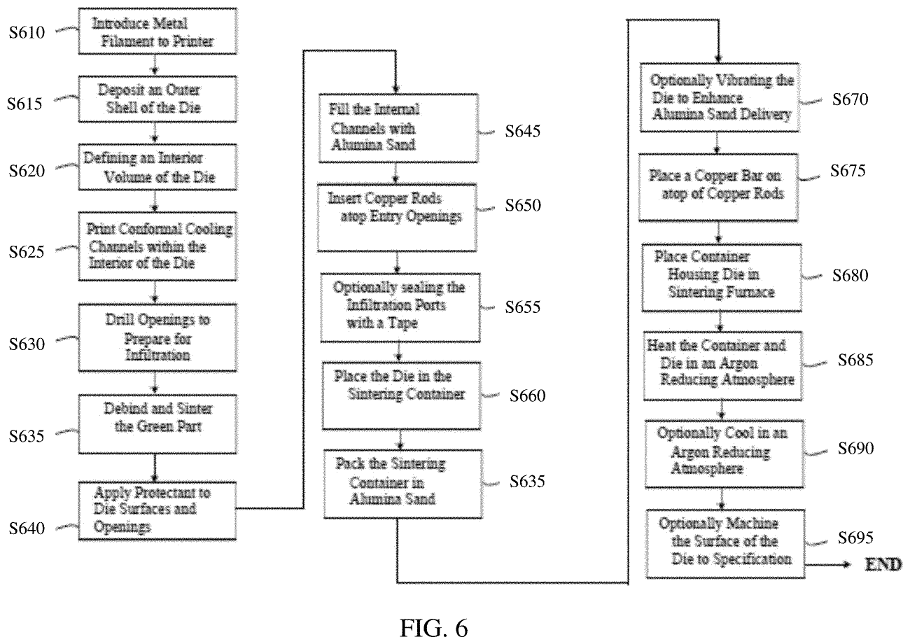

FIG. 6 is a flow chart for performing 3D-printing and infiltrating to form tool structures, dies, and die inserts, in accordance with one embodiment of the present disclosure.

Printing of a tool structure, die, or die insert involves introducing a metal filament, S610 for example, 17-4 stainless steel, to a printer, such as a Metal X from Markforged, Inc. (Watertown, Mass., USA). Depositing the metal to form an outer shell of the die, S615. Further depositing the metal to form an interior volume of the die, S620. An infill portion and conformal cooling channels are also printed within the interior volume, S625. Above components are printed layer-by-layer as the die is printed.

The printed internal conformal cooling channels may, for example, be straight through or U-shaped.

With continued reference to FIG. 6, the resultant printed die, a green part, is prepared for composite infiltration. One or more openings were formed, e.g., drilled, into the object for flowing a second heated and molten metal into the internal volume of the die, S630. These openings were also formed for air to escape during the subsequent infiltration by the second metal, for example, copper. Optionally, these openings may be located at the corners of the geometry of the die, or another suitable area, to limit potential structural weakness imposed in a center of the mold.

Prior to infiltration the die is debound and sintered, S635.

A protectant, for example alumina felt, alumina fiber, alumina sand, and/or a commercial braze stop-off coating (e.g., water-based or solvent-based coatings) is applied to surfaces and entries or exits to control wetting of the second metal during the infiltration process, S640. A liquid protectant is applied by air brushing, painting, rolling on, or spraying. A sand-based or paste-based protectant is applied by coating, packing or spreading.

In some aspects, the protectant is a liquid protectant that can be applied to one or more features of a part, e.g., one or more internal channels. The liquid protectant may be applied by directing the liquid protectant through at least one of the one or more channels such that a layer of the protectant coats the walls of the at least one channel. For example, a liquid braze stop-off coating may be flushed through all or a substantial portion of the internal volume of a part prior to infiltration with the second metal, e.g., copper. In some aspects, the liquid protectant may be directed through the part under pressure, such as using a syringe. In some aspects, the part may be immersed in the liquid protectant. In such cases, the entire part may be immersed into a container holding a suitable volume of the liquid protectant, then the excess liquid can drip away and dry to form a coating once the part is removed. In this configuration, the liquid protectant may coat both the exterior surfaces of the part and the walls of internal channels. The immersion of parts in a container of the liquid protectant may result in a more complete coating of smaller features of the part, such as small channels relative to a solid, i.e., powdered protectant where the coating efficiency is driven by particle size and flowability.

Use of a liquid protectant may require enhanced sample preparation to ensure the liquid protectant is applied only to locations where it is needed. For example, if there are openings, i.e., drilled holes to the internal volume containing infill, these openings should be blocked to percent exposure. If there is an exposed area open to infill, the opening to the infill should be sealed to avoid coating with the protective coating the infill that we are trying to infiltrate with the second metal.

After coating the surfaces of the die, an alumina fiber blanket substantially plugs any through holes or air escape openings. Filling or packing the internal channels with alumina sand (e.g., 120 grit alumina sand) and sealing exit and entrance holes using an alumina fiber blanket may be beneficial to inhibit wetting by the second metal on printed first metal, S645.

With continued reference to FIG. 6, copper rods (about ½″ long: ¼″ diameter) are inserted into the two infiltrant entry openings in the die, S650 for infiltration of the second, i.e., liquid, metal. The rods are secured into position using an adhesive, such as an acrylic glue. Optionally, the infiltration ports (openings) are covered or sealed with masking tape, S655.

The die with the attached rods is placed in a container, S660. The container housing the die is packed with alumina sand, S665. Optionally, vibrating the container with the part covered in alumina sand may enhance sand delivery to specific regions of the die, S660, and encases the die to be infiltrated in the sand such that only a small portion, e.g., about ¼″ of the rods in the infiltrant entry openings are visible.

In some aspects, a lower melting point temperature metal is placed or suspended on top of the rod ends, S675. For example, a bar, such as a copper bar having dimensions of 1″×1″, is placed on top of the exposed copper rods so that the stubs enter pre-drilled blind holes in the copper rod and the alumina sand is packed around the plate, S675. Optionally, the copper bar is placed on the attached rods before the die was placed in the container and packed with alumina sand.

The die is placed into a container. The container housing the die is placed into a sintering furnace, S680, and heated to between 1150° C. about 1190° C. in an argon reducing atmosphere, S685. The die in the container is heated for about 5 minutes to about 120 minutes, depending on oven conditions. In some aspects, the die in the container is heated for about 5 minutes to about 120 minutes, about 10 minutes to about 110 minutes, about 15 minutes to about 100 minutes, about 20 minutes to about 90 minutes, about 25 minutes to about 80 minutes, about 30 minutes to about 70 minutes, or about 40 minutes to about 60 minutes. In certain aspects, the die in the container is heated for about 30 minutes.

The solid copper, i.e., the copper rods and copper bar, is heated in the presence of argon and hydrogen to melt the solid copper and form a liquid copper. The liquid copper infiltrates the openings in the outer shell of the object. The liquid copper flows into and fills the internal volume of the die mold. The liquid copper substantially wets to the steel and occupies the steel infill volume. Optionally, the die is cooled in the presence of argon and hydrogen after infiltration is complete, S690.

Post-infiltration machining of a surface of a metal-infiltrated die is be done to adjust or correct the dimensions to exact specifications, S695. After infiltration, die surfaces and channels were inspected and shown to be clear and clean of deposits from the second metal. Optionally, brushing of the surface with a brush may clean most of the any remaining coating residue, for example removing surface discoloration left behind from an applied braze stop-off coating.

In some embodiments, an interior of a sintered steel mold can be printed using an infill and successfully infiltrated with liquid copper forming a bi-metal copper-steel composite in the interior mold volume.

In some aspects, an infill of a continuous gyroid or an alternating stacked rectangular geometry can be used for printing a part, e.g., a mold. In some aspects, both geometries may result in continuous internal steel reinforcement that may provide unimpeded flow-through access of liquid copper to all or a substantial portion of the interior volume of the part. In some aspects, a rectangular infill can be varied as a function of percentage infill continuously between 0% and 100% solid.

In some aspects, to avoid excessive copper deposit on an outside mold surface, a coating with a protectant before infiltration, for example a stop-braze coating, may be applied to the part.

In some aspects, to keep internal mold channels open for a coolant flow, the channels may be filled, e.g., using vibrations, with alumina sand prior to infiltration of the second metal.

In some aspects, to keep internal mold channels open for a coolant flow, the channel exit and/or entrances may be packed with an insulating material, e.g., an alumina thermal insulation blanket material.

In some aspects, to keep through holes for bolts or other fasteners open, an insulating material, e.g., an alumina blanket filler, may be used without a particulate filler.

In some aspects, an infiltrant, such as liquified copper, may consume the first metal infill disposed near, i.e., within 10-20 mm, of the mold entrance point and may form an alloy of the first and second metals, e.g., a Cu-2.8% Fe alloy, that fills a substantial portion of the mold internal volume, e.g., in-between steel infill.

Table 2 provides information on thermal and mechanical properties of bi-metal copper-steel composites that form inside a sintered mold after copper infiltration.

TABLE 2
Material Properties for bi-metal composites using different first metals

| | | | Infill | Copper | Thermal | Young's | Yield |
|---|---|---|---|---|---|---|---|
| Composite | Infill | Infill | Density | Infiltraton | Conductivity, | Modulus | Strength, |
| material # | Alloy | Type | Setting | Alloy | W/mK | GPa | MPa |
| 1 | H13 | Gyroid | 60 | C102 | 108 | 110 | 380 |
| 2 | 17-4 | Rect. | 49 | C102 | | 99 | |

### EXAMPLES

The following examples illustrate some embodiments and aspects of the disclosure. It will be apparent to those skilled in the relevant art that various modifications, additions, substitutions, and the like can be performed without altering the spirit or scope of the disclosure, and such modifications and variations are encompassed within the scope of the disclosure as defined in the claims which follow. The following examples do not in any way limit the disclosure.

### Example 1

The present Example describes a method of forming an injection mold in accordance with an embodiment of the present disclosure.

### Materials and Methods

Samples were printed using a Markforged Metal X extruding a filament including H13 tool steel.

A die insert for injection mold was printed using H13 tool steel. The die insert was printed with a substantially solid outer shell and an interior volume defined by the shell. The interior volume of the die insert was printed with an infill geometry defined by a gyroid pattern.

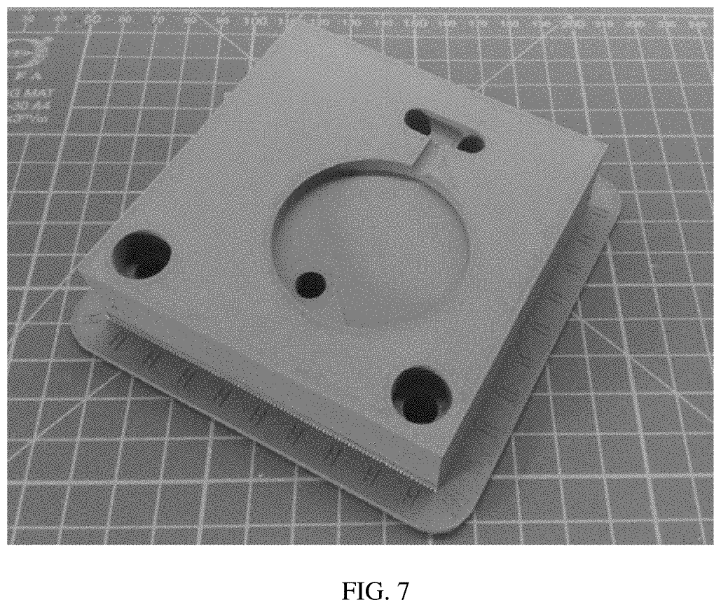

FIG. 7 is an image of a printed green part showing a die insert for an injection mold.

In the green state, one or more openings, holes were drilled in the bottom the die insert or mold. The one or more openings were configured to allow access to interior volume of the die insert. The openings allow entry of the liquid metal of the second metal. The openings allow exit of gas during the infiltration process.

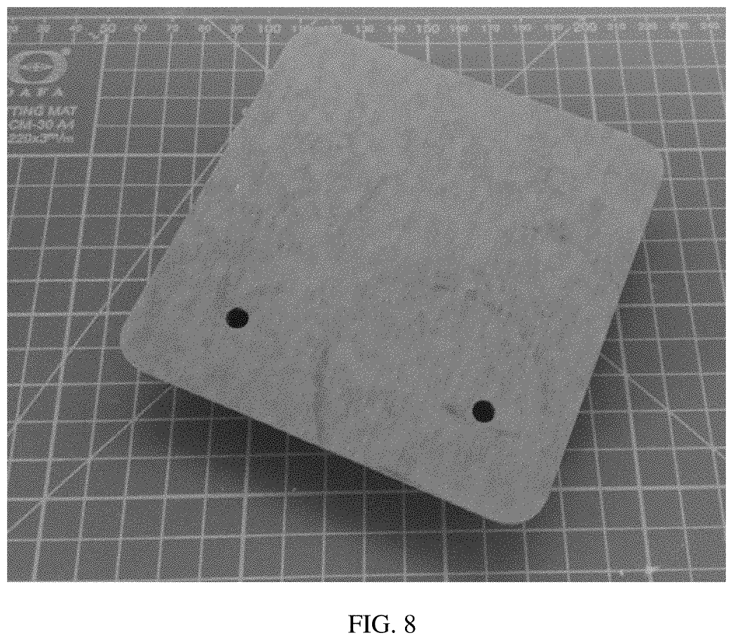

FIG. 8 is an image showing two holes formed or drilled in a surface the green part to serve as infiltrating gates for molten copper to access interior volume of the part.

The printed part was solvent debound and sintered according to an H13 tool steel wash and debind schedule. The sintered die insert was placed into a stainless-steel container filled with alumina powder.

The exposed surfaces and openings were filled with alumina powder.

A quantity of copper having a volume exceeding the interior volume of the sintered die insert was suspended or placed on top of the die insert. The die insert was placed in a container.

The container housing the die insert was placed into a Sinter I sinter furnace. The sinter furnace was heated to temperature of 1190° C. in a forming gas atmosphere, specifically argon and hydrogen.

The copper melted and flowed into the interior volume of the die insert infiltrating it.

Upon cooling the copper solidified.

Excess copper on top of the die insert fed solidification shrinkage.

Upon solidification and cool down, the die insert was extracted and its internal structure evaluated.

### Example 2

The present Example describes a method of forming an injection mold in accordance with an embodiment of the present disclosure and estimating the interior volume.

### Materials and Methods

Samples were printed using a Markforged Metal X printer extruding a filament including H13 tool steel to print a die insert that is useful for injection molding. The die insert was printed with a substantially solid outer shell and an interior volume defined by the shell. The die insert was printed with an infill geometry within the interior volume having a gyroid pattern.

In the green state, one or more openings, holes were drilled in the bottom the die insert or mold. The one or more openings were configured to allow access to interior volume of the die insert. The openings allow entry of the liquid metal of the second metal. The openings allow exit of gas during the infiltration process.

The printed part was solvent debound and sintered according to a tool steel wash and sinter schedule. The sintered die insert part was placed into a stainless-steel container and the container was filled with alumina powder.

A quantity of copper having a volume exceeding the interior volume of the sintered die insert was placed or suspended on top of the die insert. The die insert in the container was placed into a Sinter I sinter furnace. The sinter furnace was heated to temperature of 1190° C. in a forming gas atmosphere, specifically argon and hydrogen. The copper melted and flowed into the interior volume of the die insert infiltrating it.

Upon cooling the copper solidified.

Excess copper on top of the die insert fed solidification shrinkage. Upon solidification and cool down the die insert was extracted and its internal structure evaluated.

The interior volume of the die insert was assessed by filling it with water under vacuum.

The interior volume was estimated to be about factor of two smaller than calculated values based on software (Eiger, Markforged, Inc., Watertown, Mass., USA) data. It was theorized that poor wettability of the green part by water could not be overcome even under a pressure of one atmosphere.

After the part was sintered using a standard H13 schedule in the Sinter I sinter furnace, the interior volume of the part was again measured by filling it with water. The water readily wet to the steel, so no external pressure was necessary.

The interior volume was reasonably estimated.

### Example 3

The present Example describes a method of forming an injection mold in accordance with another embodiment of the present disclosure.

### Materials and Methods

A die insert for injection mold was printed using H13 tool steel.

The die insert was printed with a substantially solid outer shell and an interior volume defined by the shell and an infill geometry defined by a gyroid pattern within the interior volume.

In the green state, one or more openings, holes were drilled in the die insert or mold. The one or more openings were configured to allow access to interior volume of the die insert. The openings may allow entry of the liquid metal of the second metal. The openings may also allow exit of gas during the infiltration process. Two holes were added to provide for air escape during infiltration of the molten copper.

The printed part was solvent debound and sintered according to a tool steel wash and debind schedule. The sintered die insert was placed into a stainless-steel container filled with alumina powder.

The openings were filled with alumina powder, 120 grit white alumina sand. The opening for the infiltrant, i.e., two gates and holes on a surface of the mold, were protected with pea-size acrylic glue blobs. The glue blobs were ground flat to ensure good contact with copper stock.

All cavities were packed with alumina or FIBERFRAX® material.

A 1″×1″ copper bar (C101 copper) was placed on top of the gates. Alumina sand was packed all around the copper bar.

A few mm thick layer of alumina sand was packed on top of the mold.

The infiltration run was performed in a Sinter II sinter furnace using modified 17-4 stainless steel sintering schedule (specifically, using a 1190° C. peak sintering temperature instead of 1150° C. standard to make sure copper was completely molten).

After the infiltration run was over, the container was extracted. The copper had been successfully melted and wetted to the steel surface within the interior of the die insert.

However, the copper also wetted to the surface where alumina sand was in direct contact with part surface. The alumina sand should have shielded the part surface from copper wetting. It is believed that an air pocket formed between the part and alumina sand. It was theorized that to avoid occurrences of such unwanted extended wetting of the surface, a more aggressive protection of specific surface was required.

### Example 4

The present Example describes a method of forming an injection mold in accordance with another embodiment of the present disclosure.

### Materials and Methods

A die insert for injection mold was printed using a 17-4 stainless steel.

The die insert was printed with a substantially solid outer shell and an interior volume defined by the shell and an infill geometry defined by a gyroid pattern within the interior volume.

The die insert geometry was further printed with internal channels added to the geometry. Specifically, one U-shaped channel and one straight through channel we added. The goal of introducing the channels was to if by sealing the channel entrances with FIBERFRAX® ceramic insulation, the channels could be protected from wetting by the liquified copper and to be made liquid-tight by copper infiltrating into the rest of the die body.

In the green state, one or more openings, holes were drilled in the die insert or mold. The one or more openings were configured to allow access to interior volume of the die insert. The openings may allow entry of the liquid metal of the second metal. The openings may also allow exit of gas during the infiltration process. Specifically, two openings were added to provide entry for infiltration of the molten copper. Three additional openings were added to allow air to escape during the subsequent copper infiltration.

The manner in which the die insert contacted the copper infiltration stock was modified compared with earlier examples. As noted above in Examples 1-3, a liquid adhesive was used to fill the openings in the die and ground flat. In this example, two C-101 copper rods were secured into the openings that were drilled into green part die insert using an adhesive before the green part die insert was sintered.

The green part die insert was washed and debound according to the washing schedule for 17-4 printed parts. The die insert was subsequently sintered using a standard schedule for 17-4 printed parts.

Prior to infiltration, all holes and channel openings were sealed with FIBERFRAX® insulation. Additionally, to make the outer surface of the die insert resistant to wetting by the molten copper, a layer of boron nitride (BN) paint was applied on all sides of the die insert before it was place in 120 grit alumina sand.

A copper bar stock was placed atop of the two C-101 copper rods sticking out of the mold of the covered die insert. The die insert was placed into a container.

Next, the container housing the die insert was covered by the 120 grit alumina sand and placed into a Sinter II sintering furnace. The sintering furnace was run using the standard sintering regime for 17-4 parts, except that the peak temperature was changed from 1155° C. to 1190° C.

The copper bar stock was melted and the liquid copper infiltrated into the steel die insert. The die insert was extracted from the container.

The die insert was completely covered with copper despite the BN coating of the surface of the die insert. The BN paint did not protect the steel surface from being coated with copper. Similar to the prior example, the mold cavity was not filled with copper. The printed channels were adequately protected by the FIBERFRAX® insulation at the locations where the fiber plugs were located. While not wishing to be bound by any particular theory, this is likely because the large through-holes were printed in the part were free of copper and the alumina sand was substantially packed into the cavities of the die insert. These cavities were facing upwards; the FIBERFRAX® insulation was packed densely into the holes and served as a better protector from the molten copper spreading than BN coating.

### Example 5

The present Example describes a method of forming an injection mold in accordance with another embodiment of the present disclosure.

### Materials and Methods

A die insert for injection mold was printed using a 17-4 stainless steel.

The die insert was printed with a substantially solid outer shell, an interior volume defined by the shell, and an infill geometry defined by a gyroid pattern within the interior volume. The die insert geometry was further printed with internal channels added to the geometry. Specifically, one U-shaped channel and one straight through channel we added.

In the green state, one or more openings, holes were drilled in the die insert or mold. The one or more openings were configured to allow access to interior volume of the die insert. The openings may allow entry of the liquid metal of the second metal. The openings may also allow exit of gas during the infiltration process. Specifically, two openings were added to provide entry for infiltration of the molten copper. Three additional openings were formed for air to escape during the subsequent copper infiltration.

Two C-101 copper rods were adhered into openings that were drilled into the green part die insert before the green part die insert was sintered.

The green part die insert was washed and debound according to the schedule for 17-4 printed parts. The die insert was subsequently sintered using a standard schedule for 17-4 printed parts.

Prior to infiltration, all holes and channel openings were sealed with FIBERFRAX® insulation.

The printed 17-4 steel die insert top and bottom surfaces were protected using a ceramic fiber thermal blanket. The die insert was clamped from two sides using two steel plates and secured with bolts. The thermal blanket was positioned between the top face of the die insert and a steel plate and a ceramic felt material was positioned between the bottom face of the die insert and a steel plate. The clamping plates and faces of the die inset were coated with BN.

Internal channels were filled with 120 grit white alumina sand and sealed with a ceramic fiber thermal blanket. The die insert was then place in a container and covered in alumina sand.

A copper bar stock was placed on top of the two C-101 copper rods protruding out of the mold of the sand-covered die insert.

Next the container housing the die insert covered by the alumina sand was placed into a Sinter II sintering furnace. The sintering furnace was run using sintering regime for 17-4 stainless steel parts, except that the peak temperature was changed from 1155° C. to 1190° C.

The copper bar stock was melted and the liquid copper infiltrated into the steel die insert. The die insert was extracted from the container.

After copper infiltration at 1190° C. for 2 h in an argon atmosphere, the surfaces of the die insert were protected by the alumina ceramic fiber thermal blanket and were clean. The ceramic alumina fiber thermal blanket tightly positioned against the surfaces of the die insert was provided efficient protection against copper spreading along and clinging to a steel part surface during copper infiltration.

Additionally, the surfaces of the internal channels filled with 120 grit white alumina sand and sealed with the ceramic fiber thermal blanket were open and came out clean and clear of copper coating. Packing the internal channels with alumina sand and sealing the entrances and exits of the die insert with the alumina fiber ceramic blanket was an effective technique to keep the channels open and clean from copper deposits.

The sides of the die insert were covered with a heavy copper deposit. It was confirmed that boron nitride paint as applied to these surfaces did not protect the steel surface from being coated with copper.

Water tightness of the channels was tested and showed no visible leaks. Additionally, the air tightness of the channels was tested at 80 psi pressure with the die insert submerged and no bubbles were detected escaping from the pressurized and submerged part.

### Example 6

The present Example describes a method of forming an injection mold in accordance with another embodiment of the present disclosure.

### Materials and Methods

The die insert was printed using 17-4 stainless steel with a substantially solid outer shell, an interior volume defined by the shell, and an infill geometry defined by a gyroid pattern within the interior volume. The die insert geometry was further printed with internal channels added to the gyroid geometry. Specifically, one U-shaped channel and one straight through channel were added.

In the green state, one or more openings or holes were drilled in the die insert or mold. The one or more openings were configured to allow access to interior volume of the die insert. The openings may allow entry of the liquid metal of the second metal. The openings may also allow exit of gas during the infiltration process. Specifically, two openings were added to provide entry for infiltration of the molten copper. Three additional openings were added for air to escape during the subsequent copper infiltration.

Two C-101 copper rods were adhered into openings that were drilled into green part die insert before the green part die insert was sintered.

The green part die insert was washed and debound according to the schedule for 17-4 printed parts. The die insert was subsequently sintered using a standard schedule for 17-4 printed parts.

Prior to infiltration, all holes and channel openings were sealed with FIBERFRAX® insulation.

The openings were sealed with alumina fiber blanket. The internal channels were filled with alumina sand and sealed with an alumina fiber thermal blanket.

A commercial braze stop-off coating from Wall Colmonoy Co. was applied to protect specific surfaces of the die insert from copper deposit during infiltration process. Specifically, Green Type I, a water-based braze stop-off coating, was brushed-on using a paint brush. The coating was dried at 75° C. in a convection chamber furnace after application.

A copper bar stock was suspended or placed on top of the two C-101 copper rods protruding out of the mold of the covered die insert. The die insert was then place in a container and buried in the alumina sand.

Next the container housing the die insert covered by the alumina sand was placed into a Sinter II sintering furnace. The sintering furnace was run using sintering regime for 17-4 parts, except that the peak temperature was changed from 1155° C. to 1190° C.

The copper bar stock was melted and the liquid copper infiltrated into the steel die insert. The die insert was extracted from the container.

After copper infiltration at 1190° C. for 2 h in an argon atmosphere the die insert's surfaces were protected by the alumina ceramic fiber thermal blanket and were clean of copper.

The commercial braze stop-off coating was successful in protecting specific surfaces from copper deposits. However, the steel surfaces were discolored from the coating. The discoloration appeared to be only cosmetic and should not interfere with the part functionality. It is believed that the part surfaces may be lightly machined or otherwise cleaned to return them to original visual condition.

It was further noted that a depression was present on the bottom face opposite to one of the molten copper entrance points.

### Example 7

The present Example describes a method of forming an injection mold in accordance with another embodiment of the present disclosure.

### Materials and Methods

The die insert was printed using 17-4 tool steel with a substantially solid outer shell, an interior volume defined by the shell, and an infill geometry defined by a gyroid pattern within the interior volume. The die insert geometry was further printed with internal channels added to the gyroid geometry. Specifically, one U-shaped channel and one straight through channel were added.

In the green state, one or more openings or holes were drilled in the die insert or mold. The copper entrance points were placed at the corners of the part because it was believed that the depressions in the surface of the die insert following infiltration may have been caused by the location of the rods and if the copper entrance points were located in the corners of the die insert the likelihood of depressions forming would be reduced.

The one or more openings were configured to allow access to interior volume of the die insert. The openings may allow entry of the liquid metal of the second metal. The openings may also allow exit of gas during the infiltration process. Specifically, two openings were added to provide entry for infiltration of the molten copper. Three additional openings were formed for air to escape during the subsequent copper infiltration.

Two C-101 copper rods were adhered into the openings that were drilled into green part die insert before the green part die insert was sintered.

The green part die insert was washed and debound for using the schedule for 17-4 printed parts. The die insert was subsequently sintered using a standard schedule for 17-4 printed parts.

Prior to infiltration, all holes and channel openings were sealed with FIBERFRAX® insulation.

The openings were sealed with an alumina fiber thermal blanket. The internal channels were filled with alumina sand and sealed with an alumina fiber thermal blanket.

A commercial braze stop-off coating from Wall Colmonoy Co. was applied to protect the surface of the die insert from copper deposits during the infiltration process. Specifically, Green Type 11, a solvent-based coating, was sprayed on specific surfaces of the die insert using an air brush. The coating was substantially dried upon application.

A copper bar stock was suspended or placed on top of the two C-101 copper rods protruding out of the mold of the covered die insert. The die insert was then place in a container and buried in the alumina sand.

Next the container housing the die insert covered by the alumina sand was placed into a Sinter II sintering furnace. The sintering furnace was run using sintering regime for 17-4 parts, except that the peak temperature was changed from 1155° C. to 1190° C.

The copper bar stock was melted and the liquid copper infiltrated into the steel die insert. The die insert was extracted from the container.

After copper infiltration at 1190° C. for 2 h in an argon atmosphere the surface of the die insert were protected by the alumina ceramic fiber thermal blanket and were clean of copper deposits.

The commercial braze stop-off coating was successful in protecting part surfaces from copper deposits. The solvent-based coating protected the die insert and resulted in less surface discoloration or lighter surface discoloration than the water-based coating as applied in Example 6.

The cavity of the die insert was substantially free of copper deposits. The surface of the die insert was substantially free of discoloring residue left by the braze stop-off coating.

### Example 8

The present Example describes a method of forming an injection mold in accordance with another embodiment of the present disclosure.

### Materials and Methods

The die insert was printed using 17-4 stainless steel with a substantially solid outer shell, an interior volume defined by the shell, and an infill geometry defined by a gyroid pattern within the interior volume. The die insert geometry was further printed with internal channels added to the gyroid geometry. Specifically, one U-shaped channel and one straight through channel were added.

In the green state, one or more openings or holes were drilled in the die insert or mold. The copper entrance points were placed at the corners of the part because it was believed that the depressions in the surface of the die insert following infiltration may have been caused by the location of the rods and if the copper entrance points were located in the corners of the die insert the likelihood of depressions forming would be reduced.

The one or more openings were configured to allow access to the interior volume of the die insert. The openings may allow entry of the second metal. The openings may also allow exit of gas during the infiltration process. Specifically, two openings were added to provide entry for infiltration of the molten copper. Three additional openings were formed for air to escape during the subsequent copper infiltration.

Two C-101 copper rods were adhered into openings that were drilled into green part die insert before the green part die insert was sintered.

The green part die insert was washed and debound using the schedule for 17-4 printed parts. The die insert was subsequently sintered using a standard schedule for 17-4 printed parts.

Prior to infiltration, all holes and channel openings were stuffed with FIBERFRAX® insulation.

The openings were sealed with an alumina fiber thermal blanket. The internal channels were filled with alumina sand and sealed with an alumina fiber thermal blanket.

A commercial braze stop-off coating from Wall Colmonoy Co. was applied to protect the surfaces of the die insert from copper deposits during the infiltration process. Specifically, Green Type 11, a solvent-based coating, was sprayed-on using an air brush. The coating was substantially dried upon application.

A copper bar stock was suspended or placed on top of the two C-101 copper rods protruding out of the mold of the covered die insert. The die insert was then place in a container and buried in the alumina sand.

Next the container housing the die insert covered by the alumina sand was placed into a Sinter II sintering furnace. The sintering furnace was run using sintering regime for 17-4 parts, except that the peak temperature was changed from 1155° C. to 1190° C.

The copper bar stock was melted and the liquid copper infiltrated into the steel die insert. The die insert was extracted from the container.

After copper infiltration at 1190° C. for 2 h in an argon atmosphere the surfaces of the die insert protected by the alumina ceramic fiber thermal blanket were clean.

The commercial braze stop-off coating was successful in protecting part surface from copper deposits. The solvent-based coating protected the die insert and resulted in less surface discoloration or lighter surface discoloration than the water-based coating as applied in Example 6.

The cavity of the die insert was substantially free of copper deposits. The surface of the die insert was substantially free of discoloring residue left by the braze stop-off coating.

After infiltration, the die insert surfaces were clear from copper deposit. The internal cooling channels were clear and free of copper deposits.

As needed, brushing of the surface with a wire brush cleared out most of the coating residue.

The back side and working (upper) die surfaces were machined using a vertical CNC mill to make the surfaces flat and parallel and to bring the geometry of the die cavity to specification.

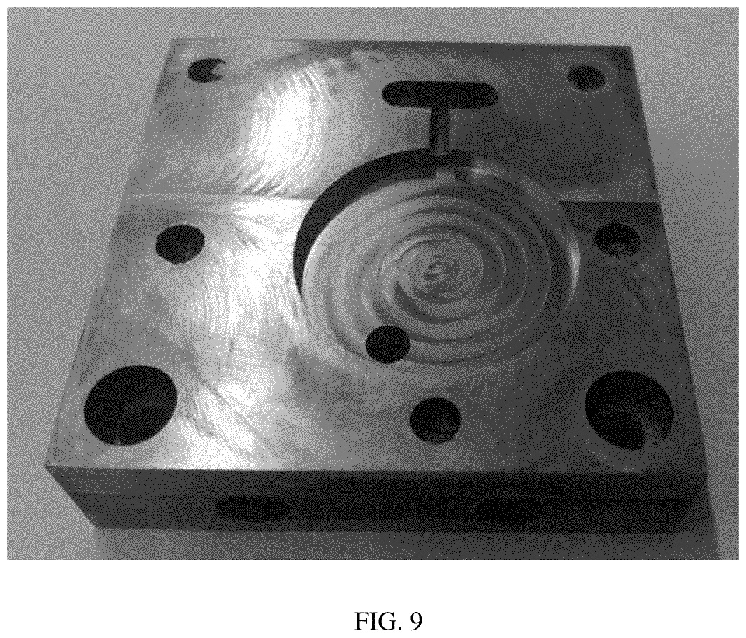

FIG. 9 is an image illustrating the resultant die for injection molding. The surface of the die was machined via a post-processing step to substantially form the die to specification.

The resultant die was used for serial injection molding trials using an injection molding press.

### Example 9

The present Example describes assessing a die insert for injection mold made in accordance with an embodiment of the present disclosure.

### Materials and Methods

A die insert for an injection mold was printed from 17-4 stainless steel in accordance with Example 5. A substantially solid outer shell and an interior volume defined by the shell with an infill geometry of a gyroid pattern in the interior volume. The die insert geometry was printed with a U-shaped channel and a straight through channel. The printed die insert was debound and sintered. The sintered die insert was prepared for infiltration with liquid copper. A copper bar stock was placed on top of two C-101 rods protruding out of the die insert. Alumina sand was packed around and into a container housing the die insert before it was placed into a sintering furnace and heated to 1190° C. thereby melting the liquid copper into the steel die insert.

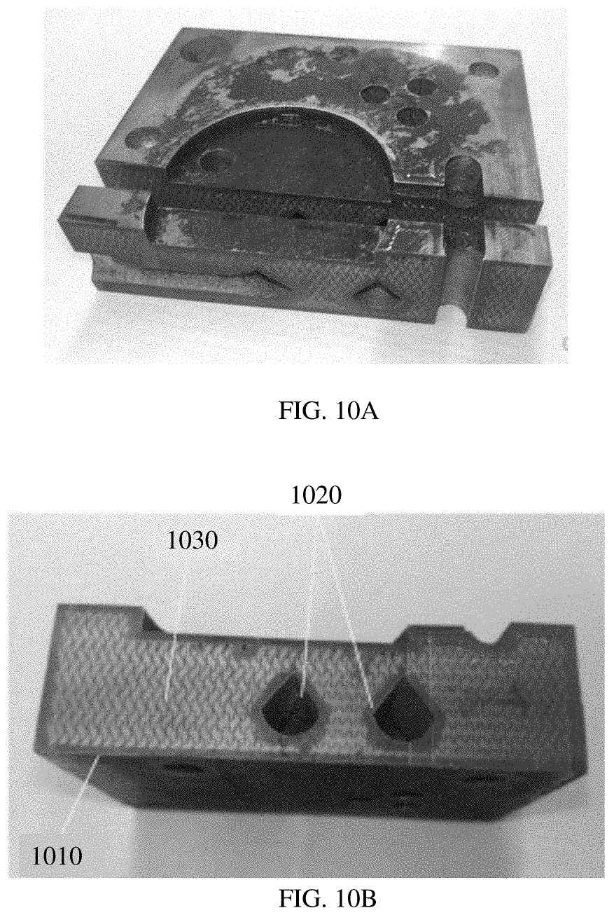

After the die insert was prepared the copper-infiltrated die was sliced via wire-EDM to expose its internal structure and microstructure. FIGS. 10A and 10B illustrate EDM slices located at the middle of the die to reveal its internal material structure and internal channels. FIG. 10A shows the die insert sliced by EDM. FIG. 10B shows the die insert sliced and viewed from the side. The inside first metal edge 1010 is shown substantially continuously surrounding the volume containing the copper infiltrated steel infill 1030. The channels 1020 used for conformal cooling the die mold are also shown.

### Example 10

The present Example describes assessing a die insert for injection mold made in accordance with an embodiment of the present disclosure.

### Materials and Methods

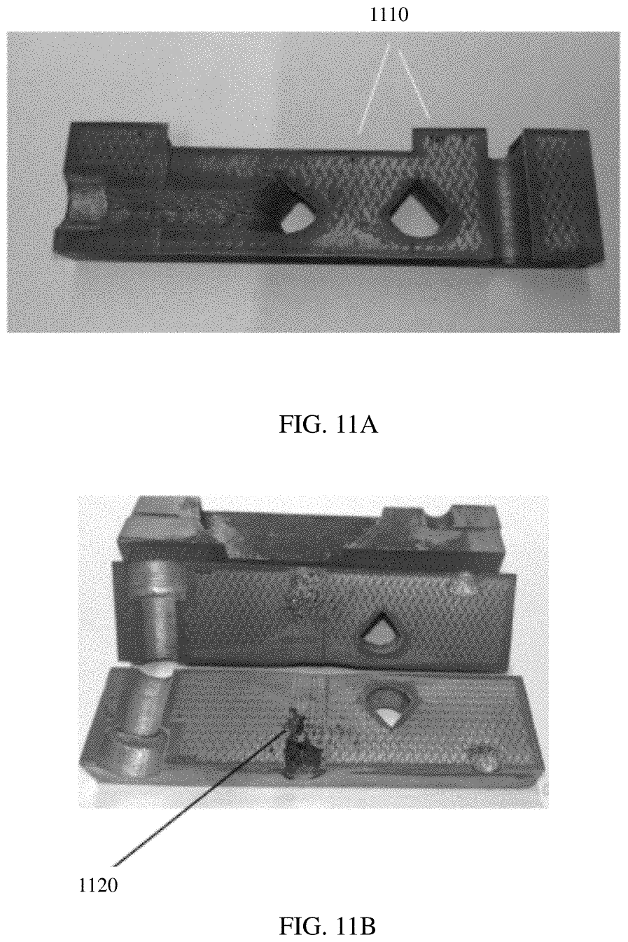

A die insert for an injection mold was printed in 17-4 stainless steel in accordance with Example 5. After the die insert was prepared, the copper-infiltrated die was sliced via wire-EDM to expose its internal structure and microstructure. FIGS. 11A and 11B show schematic representations illustrating EDM slices located at the middle of the die to reveal its internal material structure and internal channels. FIG. 11A shows the die insert sliced by EDM. Infiltration of the die insert is shown as substantially complete. Only a few pores, each indicated at 1110, are visible and localized close to the upper surface of the die insert. The interior volume of the die insert was converted from a steel infill pattern and an empty volume surrounding the steel infill into a bi-metal steel-copper composite. The empty volume surrounding the steel infill was infiltrated by liquid copper. The internal channels, the printed cooling channels of the die insert remained open and free of copper. The die insert therefore functionally remains open for circulation of a cooling liquid.

FIG. 11B shows the die insert EDM sliced and viewed from the side. The infiltrant gate area where copper entered the die insert shows evidence of macroporosity that was formed during copper crystallization 1120. To minimize this effect, the infiltrant gate area was positioned away from the surface of the die insert. On an area at the bottom of the die insert opposite to the gate opening it appears as if the incoming liquid copper flowed and dissolved the steel infill pattern and part of the floor of the die insert. As the distance from the gate increases, the dissolved area becomes smaller and finally practically disappears about 10-12 mm from the epicenter.

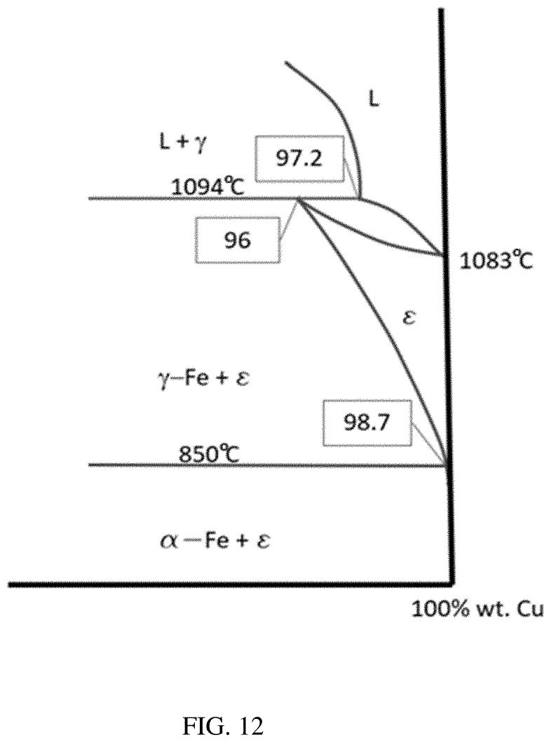

While not wishing to be bound by any particular theory, this erosion of the steel can be explained by processing conditions. At a process temperature of approximately 1190° C., about 7-8% of Fe can be dissolved in liquid copper as shown in the phase diagram in FIG. 12. It is believed that fresh, unalloyed copper coming into the die dissolves the steel it encounters first. As the liquified copper travels further, into the part, the liquid becomes enriched with iron reducing its potential to dissolve steel, i.e., becomes saturated. The erosion area could be minimized by reducing infiltration process temperature to 1145° C. (˜50° C. above the 1094° C. solidus temperature of copper) and/or using copper infiltrant alloy that already contains iron.

### Example 11

The present Example describes assessing the metallographic quality of the die insert for the injection mold made in accordance with an embodiment of the present disclosure.

### Materials and Methods

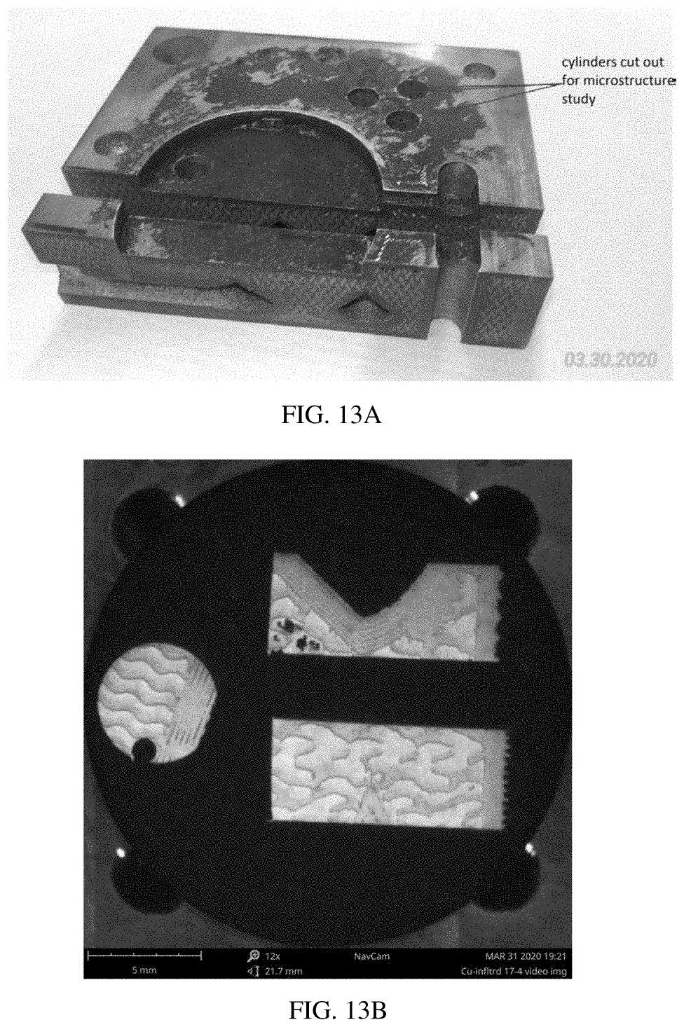

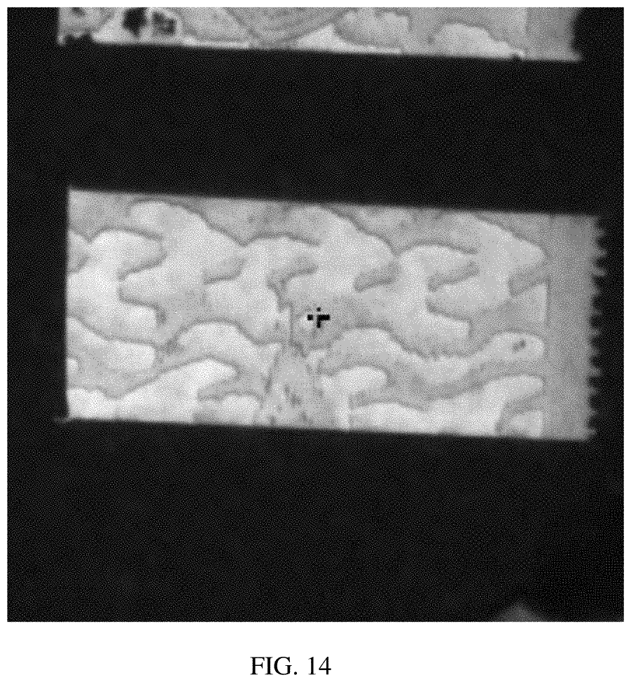

FIGS. 13A and 13B show a die insert for injection molding that was used for material microstructure analysis. FIG. 13A shows the locations where the 6-mm diameter cylinders were cut out of the die insert and used for material microstructure analysis. The cylinders were mounted in a carbon-filled phenolic compound and resulting samples ground and polished to metallographic quality for study under SEM. Resulting sample mounted in the SEM. FIG. 13B shows the cylinders internal microstructure includes intercepted internal die cooling channels, which provides an opportunity to study the composite microstructure where copper envelops steel infill and areas where copper contacts the internal channels and external walls of the die.

FIG. 14 shows a photographic image of a microstructure of a bulk cross-section of the copper/steel infill composite with a spot marked by an ‘X’.

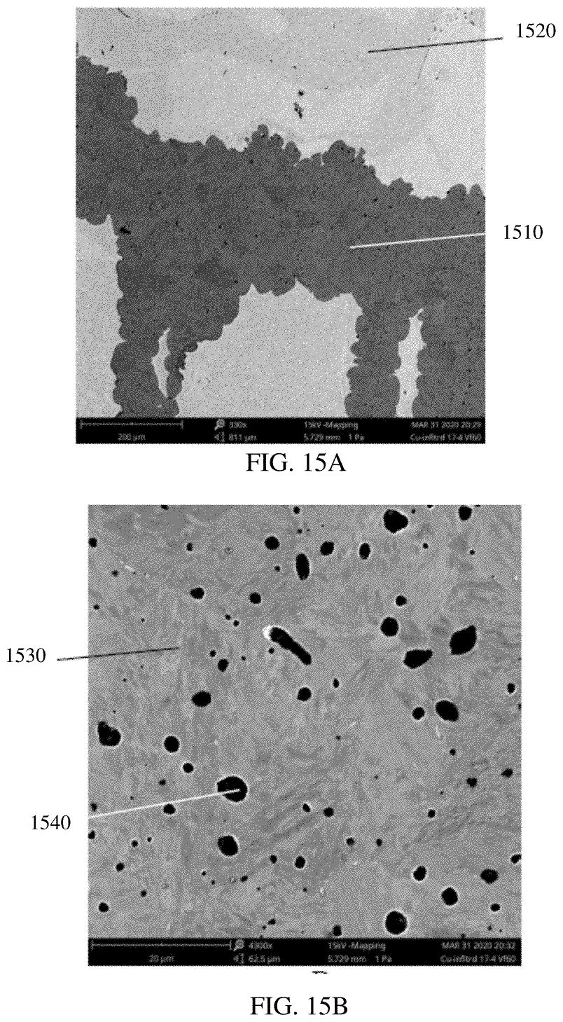

FIGS. 15A and 15B show SEM images of the microstructure at the ‘X’ in FIG. 14. FIG. 15A shows a low magnification SEM image of the microstructure. The contrast shown in the SEM image is due to a backscattered electron signal. Steel areas 1510 appear darker due to the relative lower atomic number and copper areas 1520 appear brighter due to the relative higher atomic number. FIG. 15B shows a high magnification image of an area in the bulk of the steel of the die insert. The steel area microstructure 1530 had the appearance of sintered 17-4 stainless steel including a few volume percent occupied by pores (rounded shape black spots) 1540.

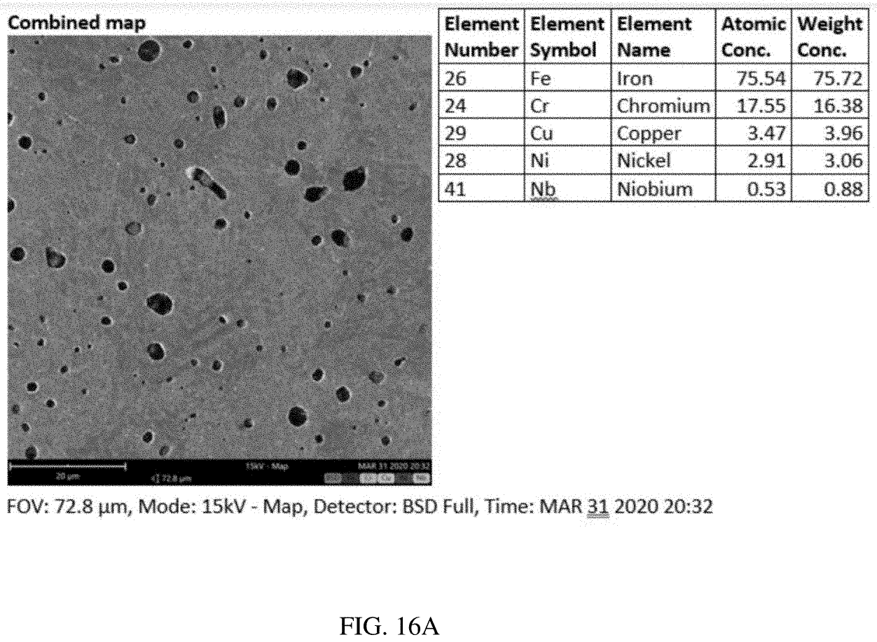

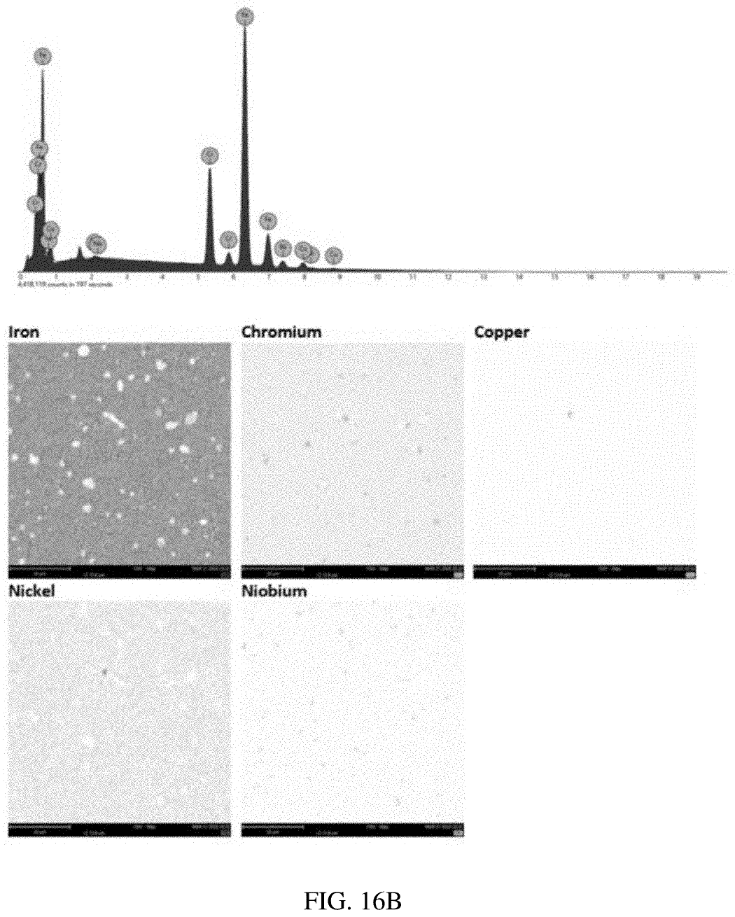

The bulk elements forming 17-4 stainless steel, e.g., copper, nickel, chromium, and iron, are transition metals and are close in atomic number. FIGS. 16A and 16B show the image results of a quantitative EDS analysis. FIGS. 16A and 16B show image results of a quantitative EDS analysis combined with X-ray mapping of the area (that is, the area marked with the ‘X’). The EDS analysis results show that the steel composite component composition in the mid-section of the steel infill in the area marked with the ‘X’ conforms to 17-4 specification.

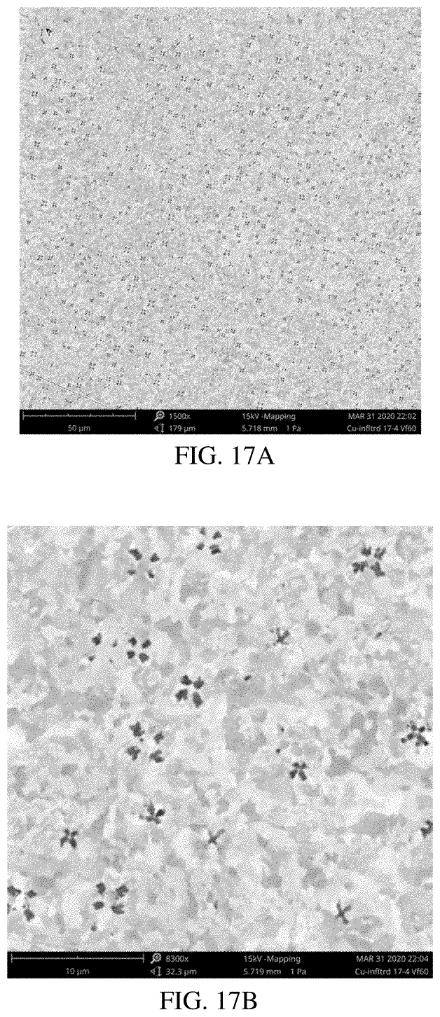

FIGS. 17A and 17B show SEM images of the microstructure in the center of a brighter contrast copper area indicating that copper contains some darker contrast phase particles. FIG. 17A shows an SEM image in low magnification showing these particles are small and their orientation is clearly aligned. Without wishing to be bound to a theory, the alignment and size of these particles lends to the belief that these particles precipitated as a result of a reaction taking place in solid state. FIG. 17B shows an SEM image in high magnification.

The bulk elements forming the chemical composition of the copper matrix include iron, chromium, and copper. The dark phase particles contain iron and chromium, iron signal being the dominant one. Iron and chromium obviously came from stainless steel component of the composite.

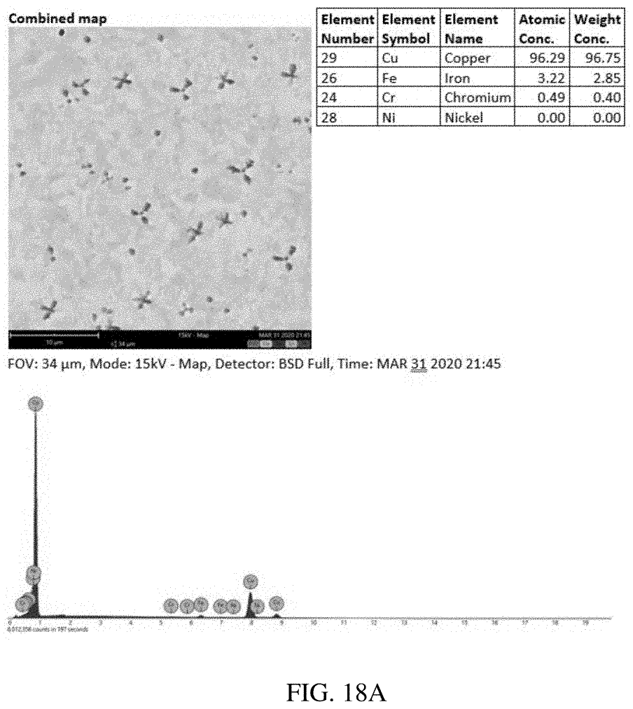

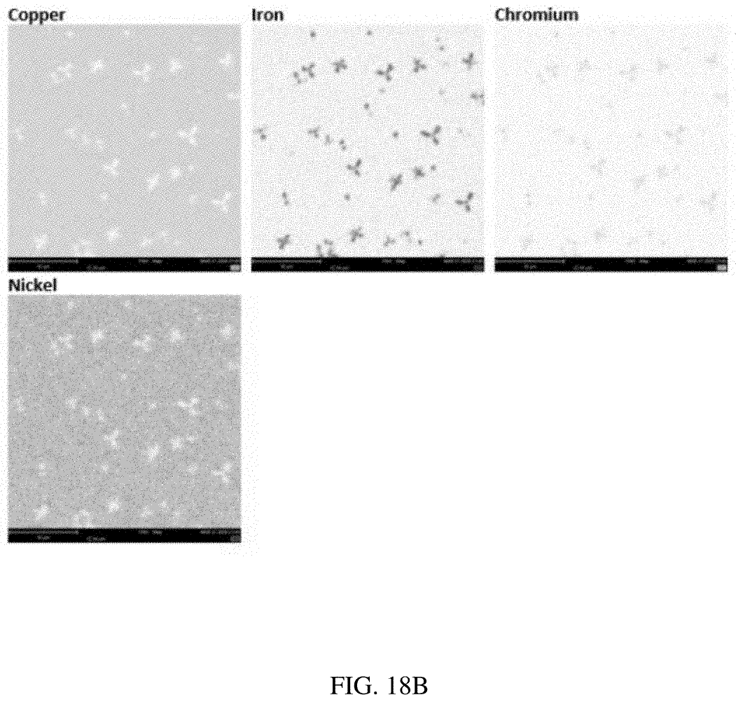

FIGS. 18A and 18B show the image results of a quantitative EDS analysis of the X-ray mapped area was carried out on the brighter contrast copper area. As noted from the inset table in FIG. 18A, there is 2.85% iron and 0.40% Cr in the analyzed area, with the balance being copper and no nickel being detected. The iron concentration is lower than predicted from a binary Cu—Fe phase diagram, but it is speculated that the addition of Cr may have changed the iron solubility in liquid copper at 1190° C.

The dark phase particles are too small to perform a quantitative EDS analysis. However, a qualitative mapping in characteristic X-rays can reveal their constitutive chemical elements. The analysis shows that the copper matrix retained about 1.16% of iron and 0.12% of chromium, while the rest of these elements are contained in dark contrast precipitated particles. Again, no nickel was detected.

According to a binary phase diagram, the iron concentration in copper should be close to zero at temperatures lower than 750° C., but phase diagrams reflect equilibrium conditions that were most likely not reached during cooling of the die after completion of the infiltration process, i.e., not enough time for solid state diffusion processes to run to completion.

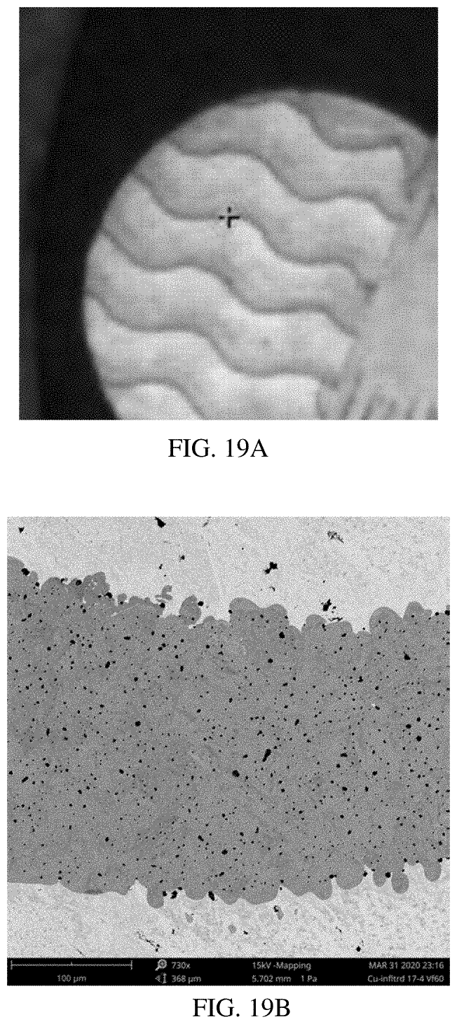

FIGS. 19A and 19B show the image of an interface between a copper matrix and a steel reinforced section. The microstructure and chemical compositions in the bulk of two composite constituents, sintered steel infill (reinforcement) and copper infiltrant (matrix), including copper, iron, chromium, and nickel. A steel reinforcement fragment with clear line geometry was selected for analysis.

FIG. 19A shows the SEM image analyzed and the ‘X’ at the analyzed area. The overall width of the infill segment is about 250 microns. FIG. 19B shows a high magnification SEM image.

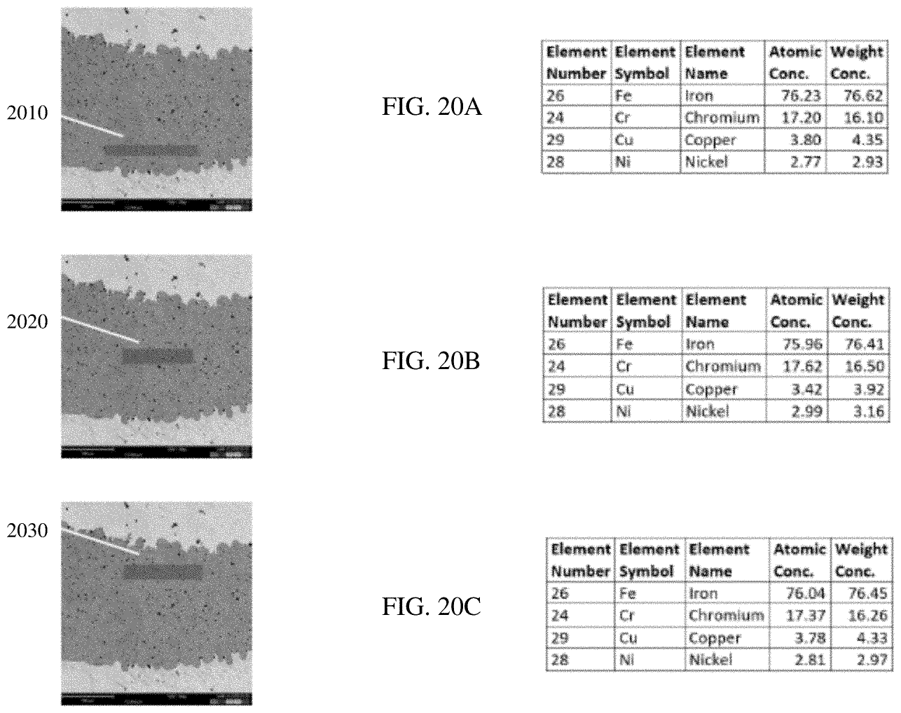

FIGS. 20A-20C show the image results of a quantitative EDS analysis performed over three different areas across the infill segment. FIG. 20A (left) shows the SEM image and (right) shows quantitative EDS analysis for location 2010. FIG. 20B (left) shows the SEM image and (right) shows quantitative EDS analysis for location 2020. FIG. 20C (left) shows the SEM image and (right) shows quantitative EDS analysis for location 2030.

The above EDS results show that, compared to a mid-section area analysis, the analysis of the periphery areas of a steel infill, i.e., those areas located close to steel-copper interface, are enriched by copper (˜4.3% vs 3.9%). Additionally, these areas are depleted of chromium (˜16.50% vs 16.17%) and nickel (˜3.16% vs 2.95%). However, this change in chemical composition is not large and leaves the infill within the 17-4 stainless steel specification.

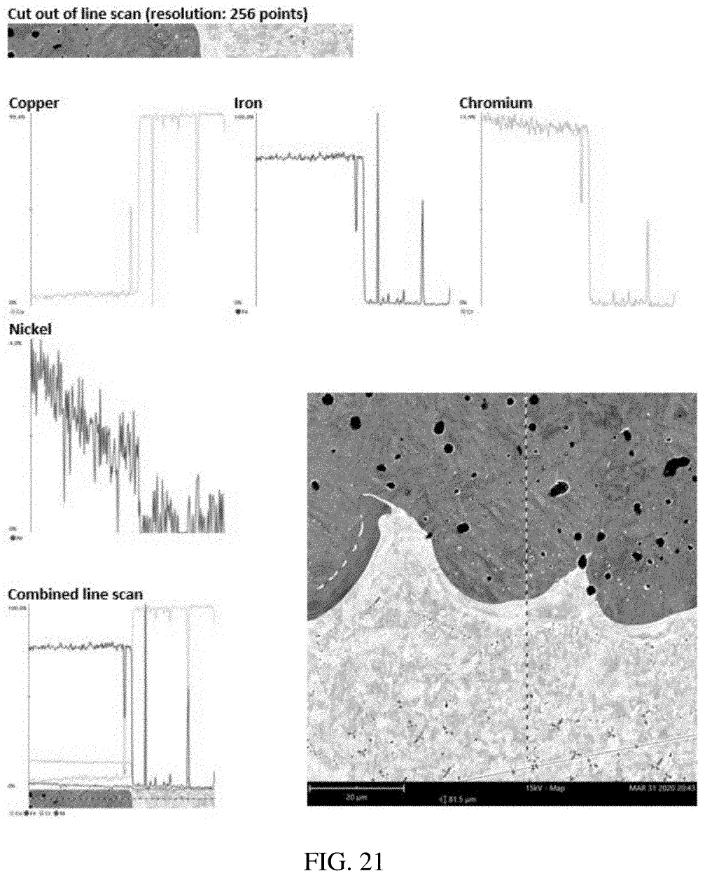

FIG. 21 shows an SEM image, results, and analysis of a line scan traversing an interface between steel and copper. Specifically, the qualitative changes in elemental concentrations as the interface boundary is crossed from steel into copper are shown. Line scan results show that on the steel side of the scan one could observe a noticeable depletion profile of chromium and nickel and weaker enrichment profile of copper as the analysis spot moves from the steel bulk towards the interface. On the copper side, a weak enrichment with chromium and iron is observed moving from the bulk copper to the interface. However, the elemental concentration profiles on the copper side appear to be much more even overall, which is explained by orders of magnitude faster diffusion rates in liquid copper compared to steel that remains solid during infiltration process. At the same time, the elemental concentration profiles are much steeper on the steel side because liquid copper is depleting solid steel interface regions efficiently since elements depleted from the steel, i.e., chromium, iron, nickel, are efficiently transported away from the interface by concentration leveling diffusion in liquid copper.

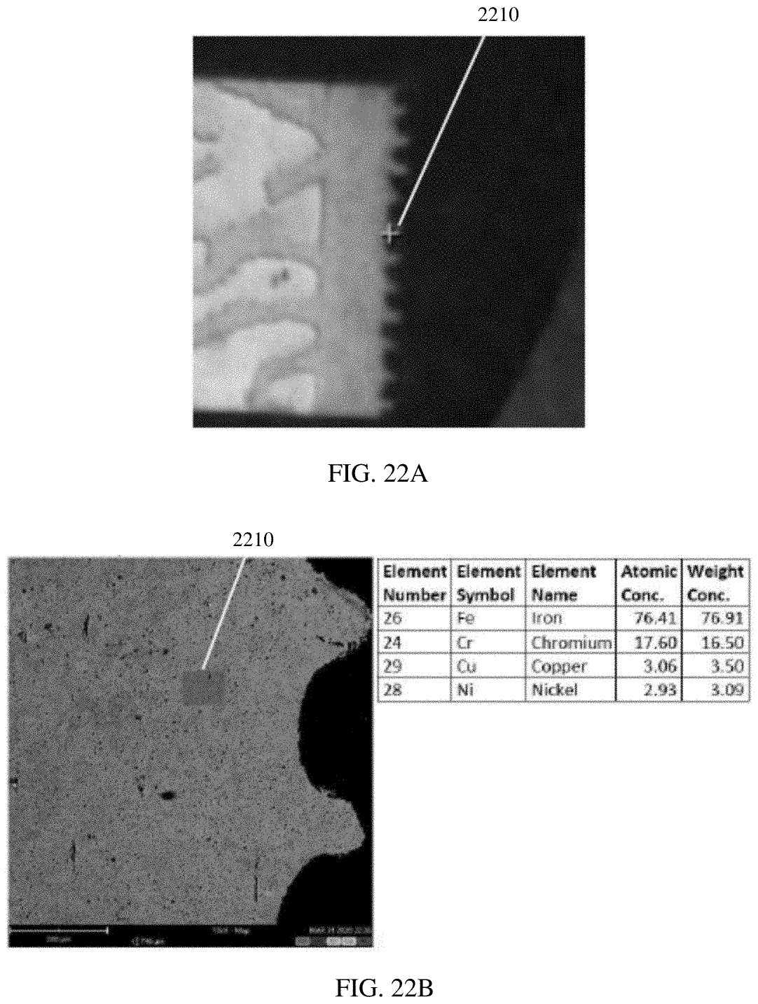

FIGS. 22A and 22B show the image results and analysis of the outer shell of the die insert for the mold. FIG. 22A shows the image location and analysis for the steel shell composition, close to the outer surface of the die. The approximate location of the test area is depicted with an ‘X’ on the photo.

An outer edge is an important location to determine if corrosion and mechanical properties following infiltration remains within prescription. FIG. 22B shows the results for the location 2210 and in particular that the steel composition close to the outer die surface remains within 17-4 stainless steel specification after copper infiltration process.

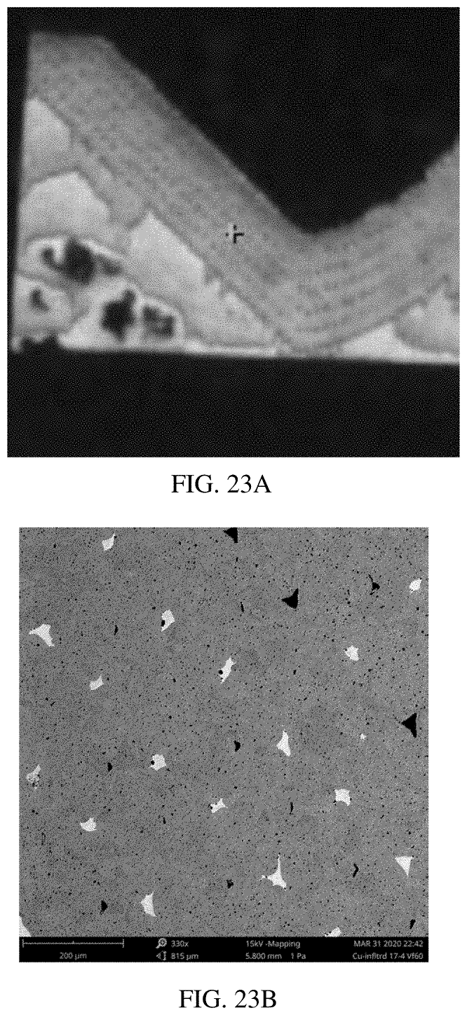

FIGS. 23A and 23B show the image results of a cooling channel of the die insert for the mold. FIG. 23A shows the image location and analysis for the steel shell composition, close to the cooling channel of the die. The approximate location of the test area is depicted with an ‘X’ on the photo.

The composite microstructure images of the copper infiltrant show that the liquid copper filled any print defects in the steel that the liquid copper infiltrant came into contact. FIG. 23B shows a fragment of an internal die conformal cooling channel wall with visible print defects caused by print under extrusion taken by camera and SEM at higher magnification. FIG. 23B shows that the copper infiltrated and filled most of the defects, i.e., the defects the molten copper came in contact with during infiltration.

### Example 12

The present Example describes assessing the thermal and mechanical properties of bi-metal copper-steel composites in accordance with an embodiment of the present disclosure.

### Materials and Methods

The bi-metal composites were sent to an outside lab for additional analysis. The outside laboratory evaluated the thermal conductivity and mechanical properties of the bi-metal composite.

A 75×50×25 mm (sintered dimensions) H13 tool steel block was printed using a 60% (maximum available) gyroid infill setting on a Markforged Metal X printer.

After printing, four air vent and two copper infiltration openings were drilled in one of the faces of the green part.

The two copper infiltration gates were located in the block corners along the longer side of the block.

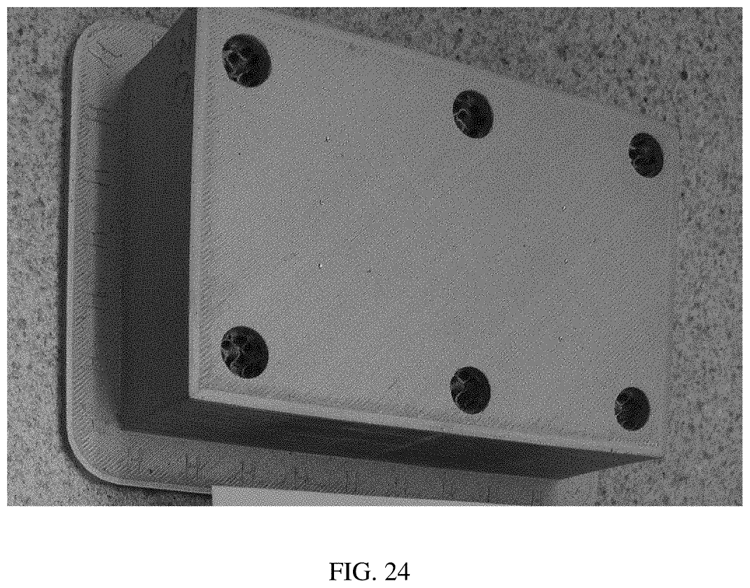

The part was washed and sintered in a Sinter I furnace using standard settings for H13 tool steel. FIG. 24 shows a photographic image of the sintered block.

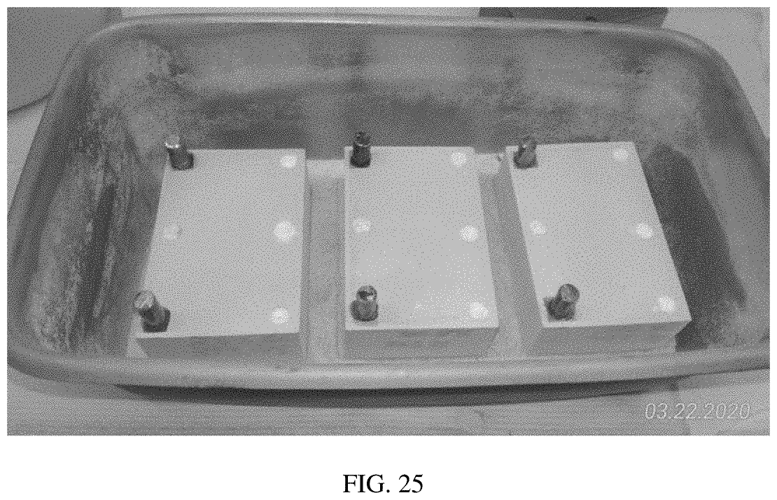

A Green stop-braze solvent-based coating was applied to the sintered block using an air spray gun. The copper rods were inserted into the two infiltrant gates in the corners and the die was placed in alumina sand in a stainless-steel container in the same way as described previous Examples. FIG. 25 shows several parts in a container, leaving only copper rod ends sticking out.

A C-102 copper alloy bar was placed on top of the block while being separated from it by a layer of alumina sand and maintaining physical communication of the copper bar and steel block using copper pins with one end inserted into a block gate and another into a hole drilled in a copper bar.

The infiltration run was conducted in an industrial Sinter-II furnace. Peak temperature was set at 1190° C. and duration of 3 hours. The temperature and atmosphere profile was the same as for standard 17-4 stainless steel in the Sinter-II furnace.

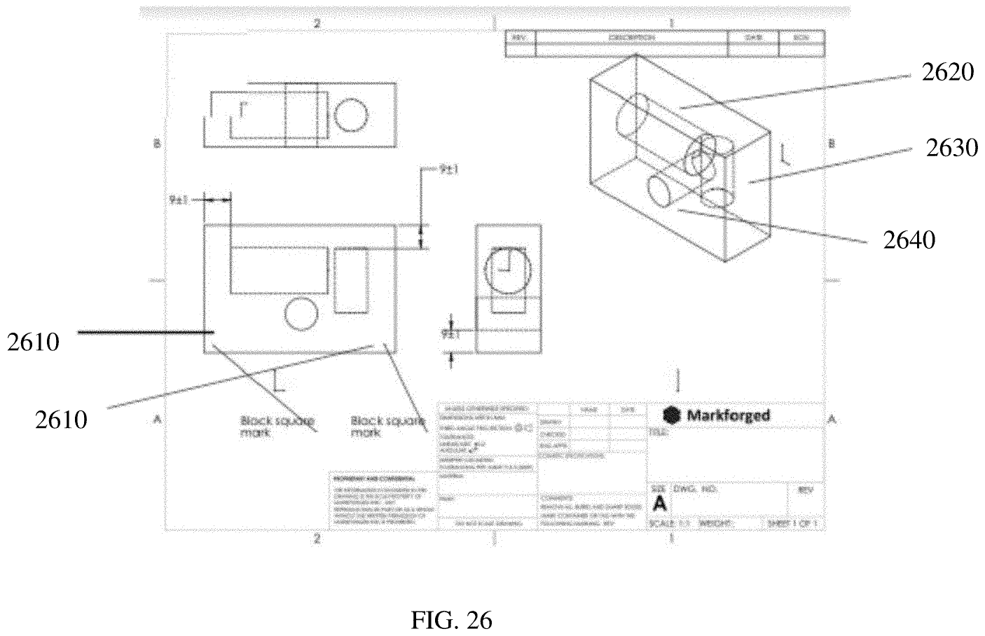

Samples for mechanical and thermal testing were cut from the composite block using wire EDM machining. FIG. 26 is a schematic representation showing the location in the composite block in which thermal conductivity and compression samples were obtained.

The black square marks, each indicated at 2610, on the schematic mark position of the copper infiltration gates. As demonstrated herein, pure liquid copper used as infiltrant erodes steel infill close to the entry point. Thus, samples, 2620, 2630, and 2640 were cut away from the gates.

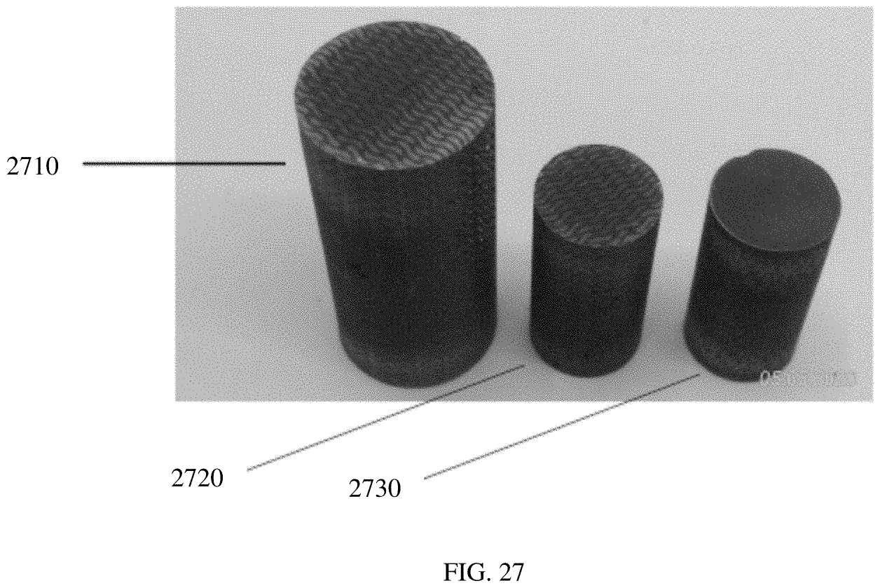

FIG. 27 shows an image of the thermal conductivity and compression samples after being prepared and cut away from the composite block. The two smaller cylinders (12.7 mm diameter, 25 mm long), 2720 and 2730 were cut for mechanical compression testing and the one larger cylinder (17.76 mm diameter, 38.1 mm long) 2710 was cut for thermal conductivity testing.

An independent lab performed the thermal conductivity tests in compliance with ASTM Standard D7984-16 using a Modified Transient Plane Source (MTPS) sensor. This is a contact method which is more suitable for a macro-scale bi-metal composite than a contact-less laser flash diffusivity method which is suitable for a homogeneous material or a micro-scale composite. As the test utilizes one surface for measurement at a time, it was possible to test both a defect-free end and an end containing the dry spot defect.

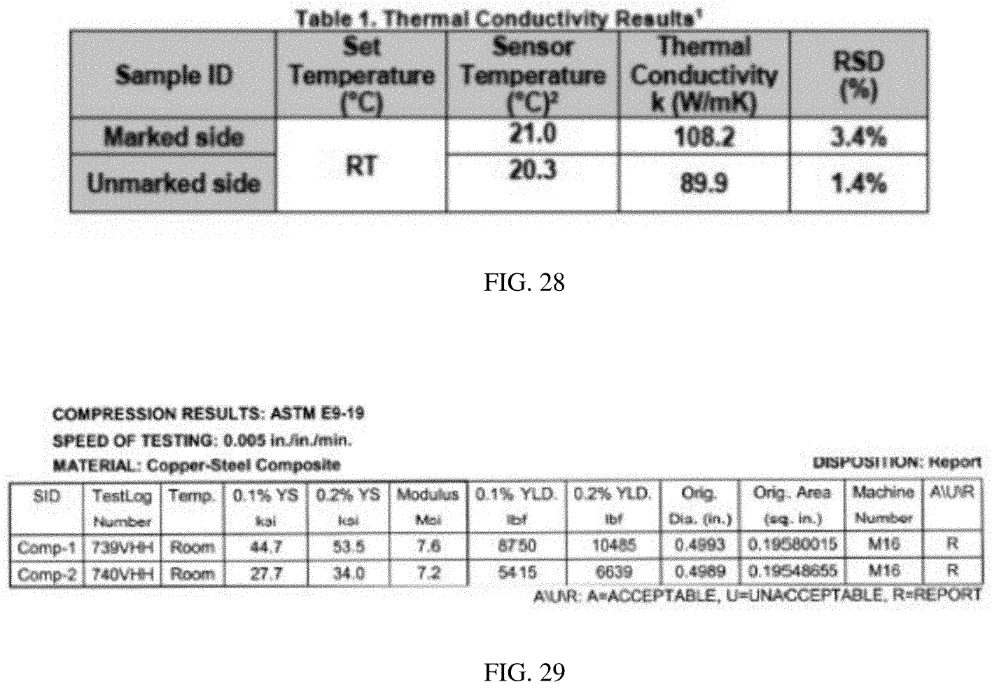

FIG. 28 shows the data produced from the thermal conductivity tests. The marked side, i.e., the defect-free side, of the material showed a thermal conductivity of 108.2 W/mK. This thermal conductivity is approximately with the value of what was expected for the material.

An independent lab performed the testing for the mechanical properties in in compliance with compression per ASTM E9-19. FIG. 29 shows the data produced from the compression tests.

Elasticity modulus for two samples, 2720 and 2730 as illustrated in FIG. 27 were tested yielding a result of 7.6 and 7.2 Msi. These values are equivalent to 52.4 and 49.6 GPa respectively. The yield strength for these two samples were tested at 369 and 234 MPa. Both the modulus and yield strength numbers are low. The elastic modulus numbers are considered suspect since copper, the less stiff component of the bi-metal composite has a table modulus of elasticity value of 120-130 GPa.

A raw data file was requested from the independent lab and plotted against internal data generated using an internal Instron testing machine and clamp-on extensometer. Samples for both tests were cut from the same block of material, i.e., a block of H13 tool steel printed using 60% gyroid infill setting and infiltrated with copper.

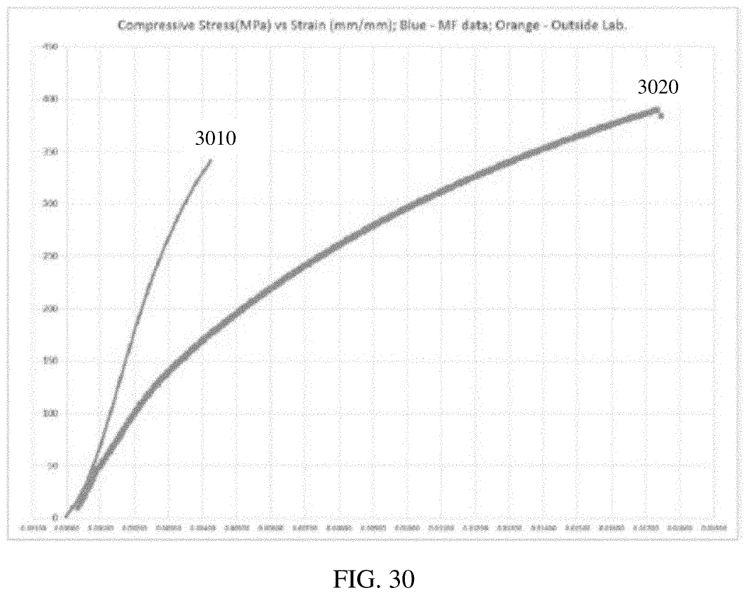

FIG. 30 shows the data plotted on the same graph. The compressive stress (MPa) v. Strain (mm/mm) plots for data collected internally 3010 and from the independent lab 3020 are different. Internal data gives an elastic modulus of 110 GPa for the composite, which is roughly double of the result from the independent lab. The root cause for the discrepancy is unclear. The internal data is closer to table values for the softest of bi-metal composite components, i.e., copper.

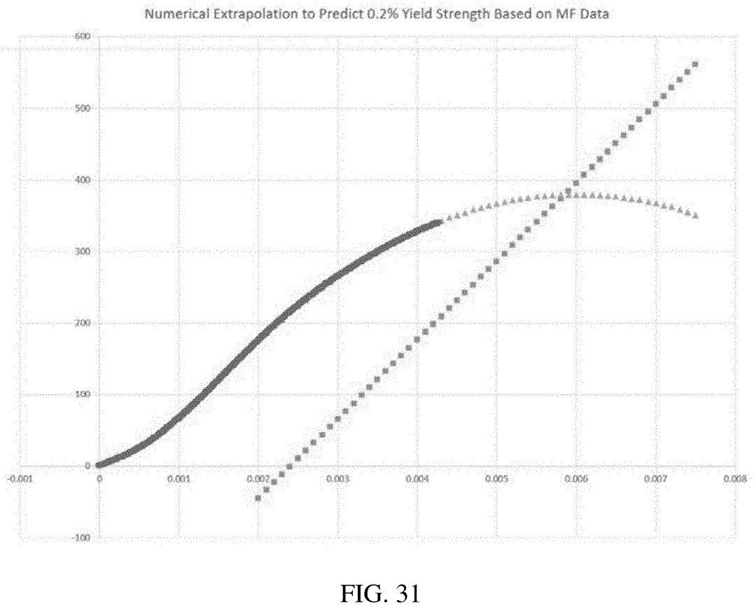

The internal Instron machine is limited to a 50 kN load and cannot deform the sample enough to directly measure the yield strength of the sample. A conservative numerical extrapolation using a 2nd degree polynomial fit gives 380 MPa as a 0.2% offset yield strength estimate for the composite material based on the internal data. FIG. 31 shows the data for the numerical extrapolation to predict 0.2% yield strength.

### Example 13

The present Example describes optimizing composite properties by varying percent infill and infill geometry in bi-metal copper-steel composites in accordance with an embodiment of the present disclosure.

### Materials and Methods

It may be beneficial for overall composite bi-metal performance when used in mold tooling applications to improve the modulus of elasticity. A 110 GPa modulus of elasticity is comparable to titanium alloys but maximizing it further would be beneficial.

It is proposed that infill geometry might affect the modulus value and a switch from a gyroid to a straight rectangular infill geometry was posed.

Blocks of H13 tool steel material was printed using a rectangular infill set at 60% density and a gyroid infill set at 60% density.

Based on calculated predictions, a 60% rectangular infill setting resulted in a greater weight of a printed block than 60% gyroid setting.

The infill geometries were controlled by the Markforged Metal X printer. The infill geometry included 10-layer high walls printed along the X direction of the printer alternating with 10-layer high walls printed in the Y direction of the printer so that the resulting infill would be permeable to liquid copper infiltration through the entirety of the block interior volume.

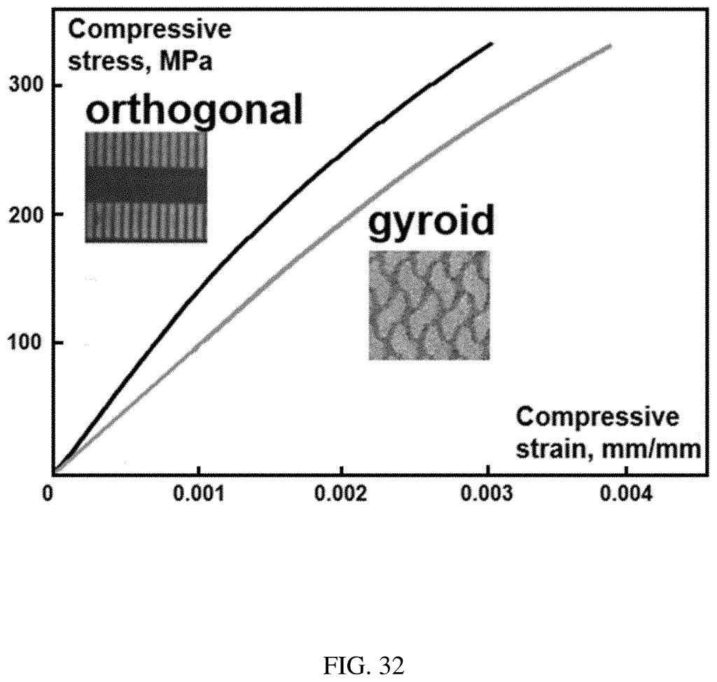

FIG. 32 illustrates stress-strain curves and inset images for machined sides of samples cut out of both the rectangular infill block and gyroid infill blocks after the steps of printing, sintering, and infiltrating with liquified copper were completed.

The H13 tool steel gyroid block used for mechanical testing, including: printing, washing, sintering and copper infiltration with C-194 copper alloy at 1190° C. for 3 hours.

Samples tested using the internal Instron machine and clamp-on extensometer.

Table 3 presents the mechanical and thermal properties for the bi-metal composite materials with the rectangular and gyroid infill patterns compared to the components alone, i.e., H13 tool steel and C-194 copper alloy.

TABLE 3
Mechanical and Thermal Properties of C194/H13 Bi-Metal Composite
and Its Components

| | Modulus of | Surface | Thermal |
|---|---|---|---|
| | Elasticity, | Hardness, | Conductivity, |
| Material | GPa | HRC/HV | W/mK |
| C194/H13 (60% | 98 | 42/410 | 110 |
| gyroid infill), | (Z direction) | | (X direction) |
| after sintering | | | |
| and infiltration | | | |
| C194/H13 (60% | 145 | 42/410 | Not measured |
| orthogonal infill), | (Z direction) | | |
| after sintering | | | |
| and infiltration | | | |
| H13 tool steel | 170 | 42/410 | 18 |
| | (As-sintered) | (As-sintered) | (Wrought steel |
| | | | manufacturer) |
| C194 copper alloy | 125 | N.A./40 | 280 |
| (Wrought annealed | (Manufacturer) | (Manufacturer) | (Manufacturer) |
| strip) | | | |

The data in the Table 3 and FIG. 32 shows that the elastic modulus for these two composites is similar. The properties were measured for a composite of H13 tool steel infiltrated with C194 copper alloy since injection molds are generally made of tool steels due to their high hardness. Composite material was tested for elastic modulus in compression—the loading mode typical for plastic injection molds—using gyroid and orthogonal shaped infill samples, both infill types printed at 60% density.

The elastic modulus of the material in compression was measured at 98 GPa for a gyroid infill and 145 GPa for orthogonal infill samples. The 98 GPa value appears to be low since it is lower than the modulus of elasticity of unreinforced copper. Estimates for the upper and lower bounds of the elastic modulus for a copper-60% vol. steel composite generally falls between 140 GPa and 152 GPa. The 145 GPa value is close to the center of the estimated range. A higher elastic modulus of rectangular, i.e., orthogonal, infill may be explained by the stiffer geometry of its vertically oriented infill reinforcement component, while the “wavy” gyroid infill reinforcement is more compliant. This suggests that orthogonal infill geometry may be better suited for the printing of injection molds.

The ability to vary the percent infill for rectangular infill beyond that of gyroid infill provides additional freedom. A mold designer needing higher stiffness for a mold can simply increasing a volume fraction of the rectangular infill. Of course, the thermal conductivity would go down as a result of copper volume fraction reduction, but the ability to tune these parameters exists.

Surface hardness of printed steel molds infiltrated with copper was measured for H13 molds at 42 HRC (average of six measurements) and coincided with hardness values for the same molds measured in the as-sintered condition. These measurements confirmed that the surface hardness of printed and sintered steel molds does not change after the copper infiltration operation. This result suggests printed and copper-infiltrated plastic injection molds would have steel-only working surfaces unaffected by copper infiltrant present inside the mold, and these surfaces would be as hard as those from traditional tool steel only molds.

The thermal conductivity of bi-metal copper-steel composite was measured using a sample cut out of a printed and copper-infiltrated H13 rectangular block with gyroid-shaped infill (60% by volume). The cylinder-shaped sample was cut with its axis oriented horizontally since based on a gyroid infill shape such orientation would produce a more conservative measurement compared to a vertically-oriented sample. Room temperature thermal conductivity of the material value was measured at 108 W/mK. This value is close to a rule-of-mixtures model estimate of 123 W/mK assuming a C-194 copper alloy thermal conductivity of 280 W/mK and a H13 tool steel thermal conductivity of 18 W/mK. The measured value exceeds (by approximately a factor of 2) the thermal conductivity of copper-infiltrated powder tool steels. Indeed, empirical models based on thermal conductivity measurements of copper-infiltrated powder tool steel estimate a thermal conductivity value of about 64 W/mK for a 60% volume fraction of steel in the composite. The superior thermal conductivity of the bi-metal composite in the present study can be explained by orders of magnitude lower interface surface area between steel and copper components. This interface presents an effective thermal barrier due to the interpenetrating millimeter-scale morphology of the two components.

### Example 14

The present Example describes reducing the chemical attack of steel by copper used during the infiltration process in accordance with an embodiment of the present disclosure.

As described in Example 11 herein, results of the EDS analysis agree with information obtained from a Fe—Cu phase diagram illustrated in FIG. 12. Indeed, according to the phase diagram, for a wide range of copper-rich alloys at solidus temperature, e.g., the peritectic reaction at 1094° C., the liquid phase composition is copper with 2.8 wt. % of iron. EDS analysis of the copper infiltrant, e.g., analysis of the whole area, including any precipitates, indicated the iron concentration was 2.85% Fe by weight. After solidification is complete, according to the phase diagram, the copper-based solid solution finds itself in equilibrium with an iron-based solid solution, and as temperature decreases, the iron phase should precipitate from the copper-based solid solution. Although the extent of reaction is difficult to estimate, according to the phase diagram, the iron concentration in liquified copper falls below 1.3 wt. % as the temperature falls below 850° C. EDS analysis of copper matrix in-between precipitated [Fe,Cr] particles indicated an iron concentration in liquified copper of 1.16%, consistent with this expectation. The equilibrium phase diagram predicts that iron concentration in copper-based solid solution must fall almost to zero as temperature falls further, but in practice the system is kinetically limited as the diffusion rate falls exponentially with temperature. Thus, iron is retained in copper as shown by EDS results in FIG. 33.

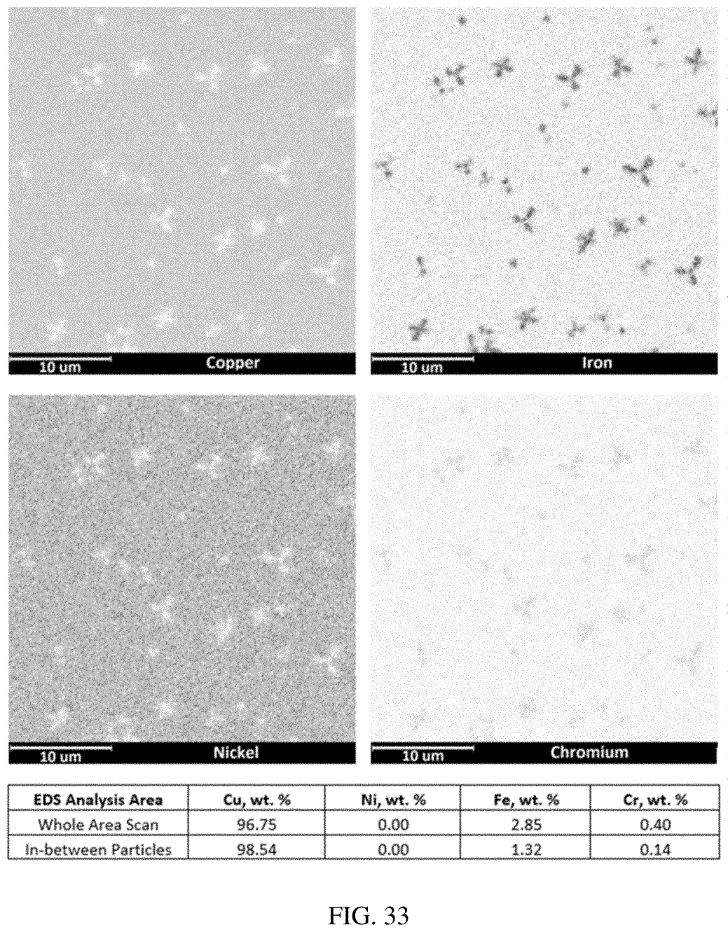

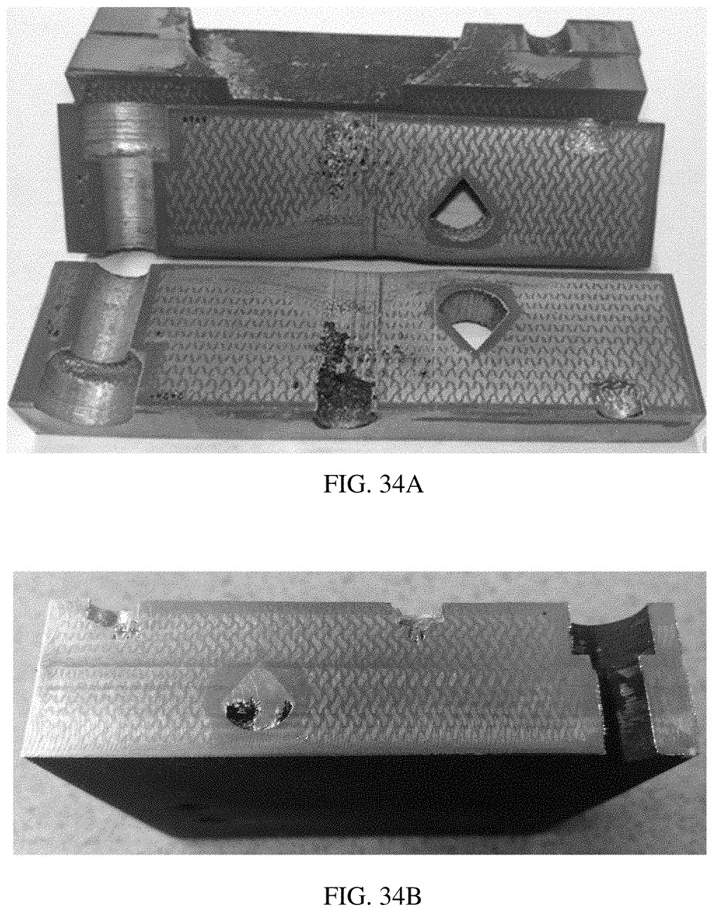

As the EDS analysis of FIG. 33 has shown, copper infiltrant transitions from pure copper into a Cu—Fe,Cr alloy during the process. It was considered whether copper reacted with steel evenly over the whole mold internal volume or whether the reaction was localized to areas where liquid copper entered the mold. FIG. 34A shows wire EDM cross-sections through the gate area of 17-4PH stainless steel mold infiltrated with copper shows that the reaction was localized to the gate areas. The reaction occurred as liquid copper was entering the mold. Infill steel material was dissolved by the liquid copper in the areas close to the gates until the liquid copper was saturated with iron. This observation pointed to a benefit of using a copper-iron alloy for infiltration instead of pure copper, to avoid or minimize liquid infiltrant attack on a steel mold infill.

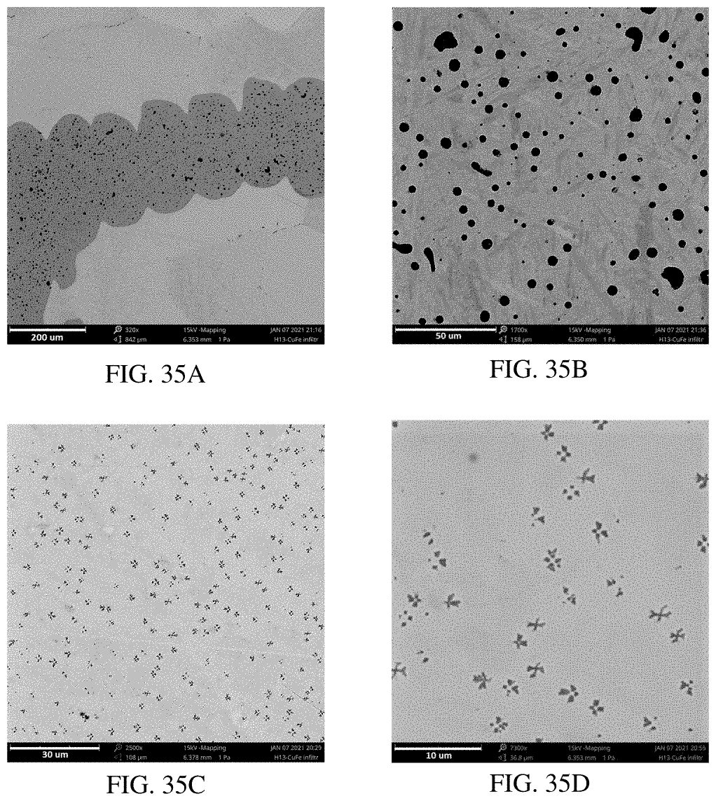

To confirm that the infill attack by liquid copper could be minimized, subsequent experiments used a commercial C-194 copper alloy, i.e., Cu-2.4% Fe, as the infiltrant. To demonstrate a copper infiltrated tool steel mold with minimized infill attack, a H13 tool steel mold of the same geometry and 60% gyroid infill was produced then infiltrated with the C-194 copper alloy using the same temperature and atmosphere regime (1190° C. for 3 h; atmosphere of Ar with 2.9 wt. % H₂). After copper infiltration, the mold was CNC milled to reveal a vertical plane cross-section passing through a gate. The resulting macrostructure view is presented in FIG. 34B. The macrostructure around the gate area showed no visible signs of copper alloy attack on steel infill structure. Note that to confirm that internal channels must be protected during infiltration, the channels were not filled with alumina sand or coated with protective coating and as a result the channels were infiltrated by the copper alloy. Additionally, the microstructure of the bi-metal composite was studied under SEM using a metallographically polished sample milled out of the H13 mold infiltrated with the C-194 alloy. As illustrated in FIGS. 35A-35D, the microstructure was qualitatively the same as for copper-infiltrated 17-4PH stainless steel mold. Steel infill was fully enveloped by copper alloy infiltrant as shown in FIG. 35A. At high magnification shown in FIG. 35B, the steel infill displays residual porosity, which for H13 parts occupies less than 5.5% by volume with pore size less than 15 μm. As shown in FIGS. 35C and 35D, copper infiltrant alloy microstructure, like with 17-4PH-Cu composites, contained mutually aligned precipitates.

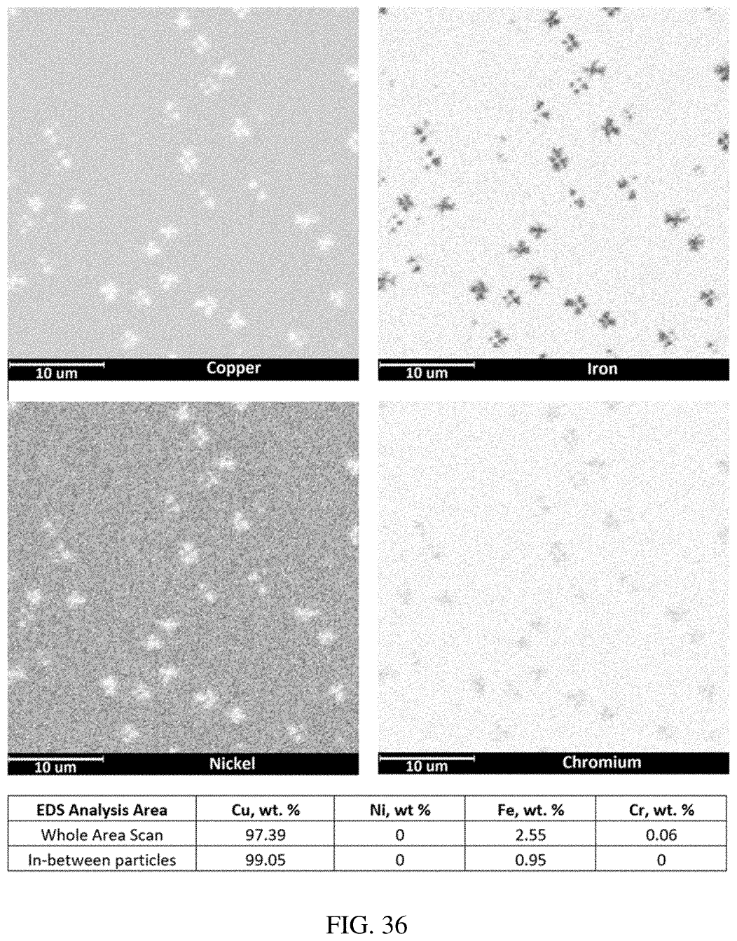

A characteristic X-ray map of C-194 copper alloy infiltrant area containing precipitates is shown in FIG. 36. The map is similar to that shown in FIG. 33 for the copper infiltrated 17-4PH stainless steel bi-metal composite that includes [Fe,Cr] precipitates in the copper matrix. One difference is that the chromium map for Cu-17-4PH composite appears to have a stronger Cr signal. The particle shapes are much better defined in Cu-17-4PH case that may be explained by the higher Cr concentration in 17-4PH stainless steel compared to H13 tool steel, which translates into a higher Cr concentration in the copper infiltrant. EDS X-ray analysis of the copper alloy matrix containing precipitates presented in FIG. 36 shows that while Fe concentration in the copper infiltrant alloy in C-194-H13 composite is close that of the Cu-17-4 composite, the chromium concentration in the copper infiltrant overall is lower compared to the Cu-17-4PH composite and is close to zero in the copper matrix in-between precipitates.

### OTHER EMBODIMENTS AND EQUIVALENTS

While the present disclosure has explicitly discussed certain particular embodiments and examples of the present disclosure, those skilled in the art will appreciate that the disclosure is not intended to be limited to such embodiments or examples. On the contrary, the present disclosure encompasses various alternatives, modifications, and equivalents of such particular embodiments and/or example, as will be appreciated by those of skill in the art.

Accordingly, for example, methods and diagrams of should not be read as limited to a particular described order or arrangement of steps or elements unless explicitly stated or clearly required from context (e.g., otherwise inoperable). Furthermore, different features of particular elements that may be exemplified in different embodiments may be combined with one another in some embodiments.

What is claimed is:

1. A method of manufacturing a part, comprising steps of:
printing the part comprising a first metal, wherein the first metal forms a wall substantially enclosing an interior volume and an infill portion within the interior volume of the part, the infill having a pattern defining structures and space within the interior volume; and
infiltrating the part with a second metal having a lower melting temperature than the first metal, the second melted metal substantially surrounding the infill patterned structures and filling the space within the interior volume of the part.

2. The method of claim 1, wherein printing the part comprises printing one or more channels within and traversing through the interior volume of the part.

3. The method of claim 1, wherein the first metal is steel and the second metal is copper.

4. The method of claim 1, wherein the first metal is steel and the second metal is magnesium.

5. The method of claim 1, wherein the first metal is titanium and the second metal is magnesium.

6. The method of claim 1, wherein the infill portion is a continuous gyroid geometry.

7. The method of claim 6, wherein the percent infill is about 50% to about 60% of the interior volume.

8. The method of claim 1, wherein the infill portion is an alternating stacked rectangular infill geometry.

9. The method of claim 8, wherein a percent infill is about 50% to about 60% of the interior volume.

10. The method of claim 1, wherein in the infiltrating step the second metal unimpededly flows through the interior volume.

11. The method of claim 1, further comprising applying a protectant on an outside surface of the part before infiltration.

12. The method of claim 11, wherein the step of applying the protectant comprises coating the outside surface of the part with a stop-braze.

13. The method of claim 1, wherein the infiltrating step substantially fills empty space within the interior volume.

14. The method of claim 1, wherein prior to the infiltrating step, comprising a step of forming one or more openings in the wall.

15. The method of claim 1, wherein prior to the infiltrating step, comprising a step of suspending a volume of the second metal above the one or more openings.

16. The method of claim 1, wherein the infiltrating step comprises heating the part with the second metal in a reducing argon atmosphere.

17. A composite metal object, comprising:
an outer metal shell comprising a first metal defining a volume, wherein the volume comprises a patterned infill of the first metal, and
wherein the volume includes a second metal substantially surrounding the infill pattern.

18. A metal die insert for a mold, comprising:
an outer metal shell comprising a first metal defining a volume,
wherein the volume comprises a patterned infill of the first metal, wherein the volume includes a second metal substantially surrounding the infill pattern; and
wherein one or more fluid tight channels enclosed within and traversing through the mold.

19. The die insert of claim 18, wherein the first metal is steel and the second metal is copper.

20. The die insert of claim 18, wherein the first metal is steel and the second metal is magnesium.

21. The die insert of claim 18, wherein the first metal is titanium and the second metal is magnesium.

22. The die insert of claim 18, wherein the outer shell is substantially the first metal.

23. The die insert of claim 18, wherein the second metal occupies empty space within any defects at an interface between the interior volume and the shell.

24. The die insert of claim 18, wherein the defects are pores.
